(19) United States
(12) Patent Application Publication
(10) Pub. No.: US 2014/0327740 A1
(43) Pub. Date: Nov. 6, 2014

(54) TRANSMISSION APPARATUS, TRANSMISSON METHOD, RECEIVER AND RECEIVING METHOD

(71) Applicant: Sony Corporation, Tokyo (JP)

(72) Inventor: Ikuo Tsukagoshi, Tokyo (JP)

(73) Assignee: SONY CORPORATION, Tokyo (JP)

(21) Appl. No.: 14/359,404

(22) PCT Filed: Sep. 2, 2013
(86) PCT No.: PCT/JP2013/073588

§ 371 Date: May 20, 2014

(30) Foreign Application Priority Data
Sep. 27, 2012 (JP) 2012-215284

(51) Int. Cl. H04N 13/00; H04N 5/44

(52) U.S. Cl. CPC H04N 13/0059; H04N 13/0029; H04N 13/0048; H04N 5/4401; H04N 2213/007
USPC 348/43

(57) ABSTRACT

If 3D data and 2D image data are transmitted from a transmission apparatus to a receiver in a time-division manner, image displaying is satisfactorily performed at the receiver side.

Image data is obtained by an image data obtainment unit, and the image data is transmitted to an external apparatus by a transmission unit. When the image data is items of image data on multiple views, for example, a left eye view and a right eye view that make up a stereoscopic image, the transmission unit transmits the image data on each of the multiple views in a stereoscopic image transfer format. Furthermore, even when the image data is the two-dimensional image data, the transmission unit transmits the image data in the same stereoscopic image transfer format.

### TECHNICAL FIELD

The present technology relates to a transmission apparatus, a transmission method, a receiver and a receiving method, and more particularly to a transmission apparatus or the like that transmits items of image data that correspond to 3D (stereoscopic) content and 2D (two-dimensional) content to an external apparatus in a time-division manner.

### BACKGROUND ART

For example, in Patent Literature 1, signaling by which a receiver is enabled to perform correct stream receiving in a case where distribution contents from a broadcasting station are dynamically changed from a 2D image to a 3D image or from the 3D image to the 2D image is disclosed. In this case, for example, when the 2D image is distributed, an AVC stream including 2D image data is transmitted, and when the 3D image is distributed, an MVC stream including items of image data on a base view and a non-base view that make up a 3D image is transmitted. When the 3D image is distributed, information associated with the base view and the non-base view is inserted into a transport stream. The receiver recognizes a dynamic change in the distribution contents and thus can dynamically switch between decoding processing and display processing, based on the associated information.

### CITATION LIST

### Patent Literature

PTL 1: Japanese Unexamined Patent Application Publication No. 2011-234336

### SUMMARY OF INVENTION

### Technical Problem

For example, it is considered that the receiver is a set-top box and that as described above, the distribution contents from the broadcasting station are dynamically changed from the 2D image to the 3D image or from the 3D image to the 2D image. In this case, items of image data (hereinafter, suitably referred to as “stereoscopic (3D) image data”) on a left eye view and a right eye view that make up the 3D image and 2D image data are transmitted from the set-top box to a monitor, for example, the television receiver, in a time-division manner through, for example, a digital interface such as HDMI.

In the related art, whereas 3D image data is transmitted in a stereoscopic image transfer format, the 2D image data is transmitted in a two-dimensional image transfer format. Because of this, when the distribution contents from the broadcasting station is dynamically changed from the 2D image to the 3D image, or from the 3D image to the 2D image, a change in a format parameter of the digital interface occurs. Now, the change in the parameter in a previous connection setting between the set-top box and the monitor occurs, a time lag occurs during a period of time from a point in time when the change occurs to the time when the image data is actually transmitted, and thus there is a likelihood that a non-display interval (a mute interval) will occur.

An object of the present technology is to enable image displaying to be satisfactorily performed at a receiver side in a case where 3D image data and 2D image data are transmitted, in a time-division manner, from a transmission apparatus to the receiver.

### Solution to Problem

A concept of the present technology is embodied in a transmission apparatus including: an image data obtainment unit that obtains image data; and a transmission unit that transmits the obtained image data to an external apparatus, in which when the image data that is obtained is items of image data on multiple views, for example, a left eye view and a right eye view that make up a stereoscopic image, the transmission unit transmits the image data on each of the left eye view and the right eye view in a stereoscopic image transfer format, and in which when the image data that is obtained is two-dimensional image data, the transmission unit transmits the two-dimensional image data in the stereoscopic image transfer format.

According to the present technology, the image data is obtained by the image data obtainment unit, and the image data is transmitted to the external apparatus by the transmission unit. For example, the image obtainment unit receives a container that has a video stream including the image data on the multiple views, for example, the left eye view and the right eye view, that make up the stereoscopic image, in a unit of an event. In the transmission unit, when the obtained image data is the items of image data on the multiple views, for example, the left eye view and the right eye view that make up the stereoscopic image, the image data on each of the multiple views is transmitted in the stereoscopic image transfer format. Furthermore, in the transmission unit, when the obtained image data is the two-dimensional image data, the two-dimensional image data is transmitted in the stereoscopic image transfer format. For example, the two-dimensional image data is transmitted through a digital interface, such as HDMI, in a wired or wireless manner.

In this manner, according to the present technology, both the stereoscopic (3D) image data (the items of image data on the multiple views, for example, the left eye view and the right eye view) and the two-dimensional image data are transmitted in the same stereoscopic image transfer format. Because of this, even though there is switching from the stereoscopic image data to the two-dimensional image data, or from the two-dimensional image data to the stereoscopic image data, the change in the format parameter of the digital interface does not occur. Because of this, a change in a parameter in a connection setting between the transmission apparatus and the external apparatus does not occur and an occurrence of non-display intervals (mute intervals) can be suppressed in the external apparatus.

Moreover, according to the present technology, for example, when transmitting the two-dimensional image data, the transmission unit may perform reformatting of the two-dimensional image data, and thus may generate first image data and second image data that have to be inserted into insertion portions of the items of image data on the left eye view and the right eye view, respectively. In this case, at the external apparatus side, even though stereoscopic image displaying processing is performed, it is possible to perform the two-dimensional image displaying that spatially and temporally achieves a full resolution with respect to display capability.

In this case, for example, the transmission apparatus may further include an information obtainment unit that obtains information for a stereoscopic display method in the external apparatus, in which according to the obtained information for the stereoscopic display method, the transmission unit may perform reformatting of the two-dimensional image data and thus may obtain the first image data and the second image data.

For example, when the stereoscopic display method is a polarization method, the transmission unit may divide the two-dimensional image data into image data in even lines and image data in odd lines, may configure the first image data from the image data in even lines, and may configure the second image data from the image data in odd lines. Furthermore, for example, when the stereoscopic display method is a shutter method, the transmission unit may configure each frame of the first image data from each frame of the two-dimensional image data and may configure each frame of the second image data from an interpolation frame between each frame of the two-dimensional image data.

Furthermore, according to the present technology, when transmitting the two-dimensional image data, the transmission unit may set the two-dimensional image data to be first image data and second image data that have to be inserted into insertion portions of the items of image data on the left eye view and the right eye view, respectively, and may transmit identification information indicating that the first image data and the second image data are the items of two-dimensional image data that are the same. In this case, at the external apparatus side, by using one of the first image data and the second image data, based on the identification information, display processing for the two-dimensional image can be performed and it is possible to perform the two-dimensional image displaying that spatially and temporally achieves a full resolution with respect to the display capability.

Furthermore, for example, according to the present technology, the transmission unit may transmit message information suggesting that a user should perform a specific viewing action, which is in accordance with the image data that is transmitted in the stereoscopic image transfer format. In this manner, at the external apparatus side, the transmission of the message information makes it possible to suggest that the user should perform a specific viewing action, and makes viewing in a correct state possible for the user. For example, if stereoscopic image displaying is performed, the message information suggests that the user should wear his/her 3D glasses (polarized glasses, shutter glasses, and the like) and conversely, if two-dimensional image displaying is performed, the message information suggests that the user should take off his/her 3D glasses.

Furthermore, for example, the transmission apparatus according to the present technology may further include a superimposition unit that superimposes display data on a message suggesting that a user should take a specific viewing action, on the obtained image data. In this manner, at the external apparatus side, the superimposing of the message display data onto the image data makes it possible to suggest that the user should perform a specific viewing action and makes viewing in the correct state possible for the user.

Furthermore, another concept of the present technology is embodied in a receiver including: a receiving unit that receives first image data and second image data that are transmitted, in a stereoscopic transfer format, from an external apparatus, and that receives identification information indicating whether the first image data and the second image data are items of image data on a left eye view and a right eye view that make up a stereoscopic image or are items of two-dimensional image data that are the same; and a processing unit that obtains display image data by performing processing on the first image data and the second image data that are received, based on the received identification information.

According to the present technology, the receiving unit receives the first image data and the second image data that are transmitted from the external apparatus in the stereoscopic image transfer format. Furthermore, the receiving unit receives from the external apparatus the identification information indicating whether the first image data and the second image data are the items of image data on the left eye view and the right eye view that make up the stereoscopic image or are the items of two-dimensional image data that are the same. Then, the processing unit performs the processing on the first image data and the second image data that are received, based on the received identification information and obtains the display image data.

For example, when the identification information indicates that the first image data and the second image data are the items of image data on the left eye view and the right eye view that make up the stereoscopic image, the processing unit processes the first image data and the second image data, and thus obtains the display image data for displaying the stereoscopic image. Furthermore, when the identification information indicates that the first image data and the second image data are the items of two-dimensional image data that are same, the processing unit obtains the display image data for displaying the two-dimensional image by using one of the first image data and the second image data.

In this manner, according to the present technology, the processing is performed on the first image data and the second image data, based on the identification information and thus the display image data is obtained. Because of this, if the first image data and the second image data that are transmitted in the stereoscopic image transfer format are the items of two-dimensional image data that are the same, the display image data for displaying the two-dimensional image can be obtained by using one of the first image data and the second image data, and the two-dimensional image displaying that achieves a full resolution with respect to the display capability is possible.

Furthermore, a further concept of the present technology is embodied in a receiver including: a receiving unit that receives image data that is transmitted, in a stereoscopic transfer format, from an external apparatus, and that receives message information indicating a message suggesting that a user should take a specific viewing action, which is in accordance with whether the image data is image data for displaying stereoscopic image or is image data for displaying a two-dimensional image; a processing unit that obtains display image data for displaying the stereoscopic image or the two-dimensional image by processing the received image data; a message generation unit that obtains message display data, based on the received message information; and a superimposition unit that superimposes the obtained message display data onto the obtained display image data.

According to the present technology, the receiving unit receives from the external apparatus the image data that is transmitted in the stereoscopic image transfer format. Furthermore, the receiving unit receives from the external apparatus the message information indicating the message suggesting that the user should perform a specific viewing action, which is in accordance with whether the image data is the image data for displaying the stereoscopic image or is the image data for displaying the two-dimensional image.

The processing unit processes the received image data and thus obtains the display image data for displaying the stereoscopic image or the two-dimensional image. Furthermore, the message display data is obtained based on the received message information. Then, the superimposing unit superimposes the message display data onto the display image data.

In this manner, according to the present technology, the display data on the message suggesting that the user should perform a specific viewing action is superimposed onto the display image data for displaying the stereoscopic image or the two-dimensional image. Because of this, it is possible to suggest that the user should perform a specific viewing action, and viewing in the correct state is possible for the user. For example, if the three-dimensional image is performed, a suggestion that the user should wear his/her 3D glasses can be provided, and conversely, if the two-dimensional image displaying is performed, a suggestion that the user should take off his/her 3D glasses can be provided.

Moreover, for example, the receiver according to the present technology may further include a control unit that controls operation of shutter glasses, based on the received message information, in which a stereoscopic display method is a shutter method.

### Advantageous Effects of Invention

According to the present technology, image displaying can be satisfactorily performed at a receiver side in a case where 3D image data and 2D image data are transmitted, in a time-division manner, from a transmission apparatus to the receiver.

### BRIEF DESCRIPTION OF DRAWINGS

FIG. 1 is a block diagram illustrating a configuration example of an image transmission and receiving system according to an embodiment.

FIG. 2 is a diagram schematically illustrating processing at a broadcasting station and processing at a set-top box in a case where 3D content or 2D content is transmitted.

FIG. 3 is a diagram for describing processing functions in the set-top box and in a television receiver.

FIG. 4 is a diagram for describing a case where stereoscopic image data is transmitted in a stereoscopic image transfer format, for example, in “3D Frame Packing,” and two-dimensional image data is transmitted in a two-dimensional image transfer format, for example, in “2D (Normal).”

FIG. 5 is a diagram schematically illustrating examples of processing by the set-top box at the transmitting side and of processing by the television receiver at the receiving side in a case where the stereoscopic image data is transmitted.

FIG. 6 is a diagram schematically illustrating the examples of the processing by the set-top box at the transmitting side and of the processing by the television receiver at the receiving side in a case where the two-dimensional image data is transmitted.

FIG. 7 is a diagram illustrating one example of processing that generates first image data and second image data from the two-dimensional image data if a stereoscopic display method is a “polarization method”.

FIG. 8 is a diagram schematically illustrating the examples of the processing by the set-top box at the transmitting side and of the processing by the television receiver at the receiving side if the 3D display method is the polarization method in a case where the two-dimensional image data is reformatted and thus is transmitted.

FIG. 9 is a diagram illustrating one example of the processing that generates the first image data and the second image data from the two-dimensional image data if the stereoscopic display method is a “shutter method”.

FIG. 10 is a diagram schematically illustrating the examples of the processing by the set-top box at the transmitting side and of the processing by the television receiver at the receiving side if the 3D display method is the shutter method in a case where the two-dimensional image data is reformatted and is transmitted.

FIG. 11 is a diagram schematically illustrating the examples of the processing by the set-top box at the transmitting side and of the processing by the television receiver at the receiving side in the case where the two-dimensional image data is transmitted.

FIG. 12 is a block diagram illustrating a configuration example of a transmission-data generation unit that generates a transport stream TS in the broadcasting station.

FIG. 13 is a diagram for describing the inserting of a multiview_view_position SEI message into a “SELs” portion of an access unit.

FIG. 14 is a diagram illustrating a syntax of multiview view position( ) that is included in a SEI message.

FIG. 15 is a diagram schematically illustrating a configuration of a base stream and a dependent stream that are coded in a structure of a NAL unit.

FIG. 16 is a diagram illustrating the syntax of “NAL unit header mvc extension.”

FIG. 17 is a diagram illustrating the syntax of 3D_event_descriptor.

FIG. 18 is a diagram illustrating semantics of important information in the syntax of 3D_event_descriptor.

FIG. 19 is a diagram illustrating the syntax of a component descriptor.

FIG. 20 is a diagram illustrating a configuration example of the transport stream TS.

FIG. 21 is a diagram illustrating another configuration example of the transport stream TS.

FIG. 22 is a block diagram illustrating a configuration example of the set-top box that makes up the image transmission and receiving system.

FIG. 23 is a diagram illustrating a detailed configuration example of a video decoder.

FIG. 24 is a flow chart illustrating one example of a procedure for processing by the video decoder.

FIG. 25 is a flow chart illustrating one example of transmission processing in an HDMI transmission unit.

FIG. 26 is a block diagram illustrating a configuration example of the television receiver that makes up the image transmission and receiving system.

FIG. 27 is a diagram illustrating configuration examples of the HDMI transmission unit of the set-top box and of an HDMI receiving unit of the television receiver.

FIG. 28 is a diagram illustrating a packet syntax of HDMI Vendor Specific InfoFrame.

FIG. 29 is a diagram for describing a case where image data that is transmitted from the set-top box to the television receiver is dynamically changed from the stereoscopic (3D) image data to the two-dimensional (2D) image data, or from the two-dimensional (2D) image data to the stereoscopic (3D) image data.

FIG. 30 is a block diagram illustrating another configuration example of the set-top box that makes up the image transmission and receiving system.

FIG. 31 is a diagram for describing another example of 2D detection in the set-top box.

FIG. 32 is a diagram schematically illustrating a processing example of reformatting (the polarization method) in a case where the stereoscopic image data is configured from the items of image data on four views.

### DESCRIPTION OF EMBODIMENTS

An embodiment of the invention (hereinafter referred to as an “embodiment”) is described below. Moreover, descriptions are provided in the following order.

1. Embodiment

2. Modification Example

### 1. First Embodiment

[Image Transmission and Receiving System]

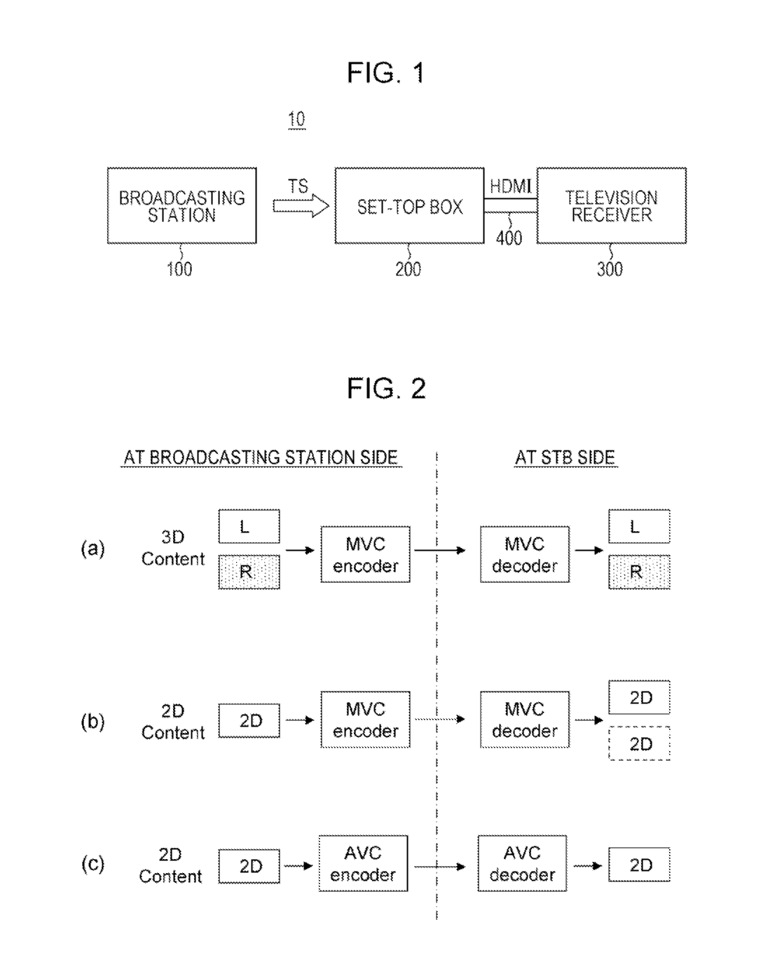

FIG. 1 illustrates a configuration example of an image transmission and receiving system 10 according to an embodiment. The image transmission and receiving system 10 has a broadcasting station 100, a set-top box (STB) 200, and a television receiver (TV) 300 as a monitor. The set-top box 200 and the television receiver 300 are connected to each other through a high definition multimedia interface (HDMI) cable 400.

The broadcasting station 100 imposes a transport stream TS as a container onto a broadcast wave and thus transmits the transport stream TS. The broadcasting station 100 becomes in a stereoscopic (3D) image transmission mode or a two-dimensional (2D) image transmission mode in a unit of an event (a program).

In the stereoscopic image transmission mode, a base stream and a dependent stream that include items of image data on a left eye view and a right eye view, respectively, that make up a stereoscopic image, are included in the transport stream TS. In the two-dimensional image transmission mode, only the base stream including two-dimensional image data is included in the transport stream TS. Alternatively, the base stream and the dependent stream that include the items of two-dimensional image data that are the same, respectively, are included in the transport stream TS.

If the base stream and the dependent stream are included in the transport stream TS, first identification information (3D signaling) indicating the presence of the dependent stream other than the base stream is inserted into the base stream. As described above, in a case of the stereoscopic image transmission mode, the base stream and the dependent stream are included in the transport stream TS. Furthermore, as described above, also in a case of the two-dimensional image transmission mode, the base stream and the dependent stream are included in the transport stream TS. Details of the identification information are described below.

Furthermore, if the dependent stream other than the base stream is included in the transport stream TS, second identification information (2D/3D signaling) identifying which one of the stereoscopic image transmission mode and the two-dimensional image transmission mode is present is inserted into the dependent stream. In other words, the identification information identifies whether or not the image data included in the base stream and the image data included in the dependent stream are the same. The details of the identification information are described below.

Furthermore, third identification information indicating which one of the stereoscopic image transmission mode and the two-dimensional image transmission mode is present is inserted into a layer of the transport stream TS. For example, the identification information is inserted into a level below an event information table that is included in the transport stream TS. A message suggesting that a user should perform a specific viewing action is added to the identification information, corresponding to the transmission mode. For example, the message suggests that the user should wear his/her 3D glasses (polarized glasses, shutter glasses, and the like) in the stereoscopic image transmission mode and suggests that the user should take off his/her 3D glasses in the two-dimensional image transmission mode. The details of the identification information are described below.

The set-top box 200 receives the transport stream TS that is imposed onto the broadcast wave and thus is transmitted from the broadcasting station 100. The base stream and the dependent stream that in the stereoscopic image transmission mode, include the items of image data on the left eye view and the right eye view, respectively, that make up the stereoscopic image, are included in the transport stream TS. Furthermore, in the two-dimensional image transmission mode, only the base stream including the two-dimensional image data is included in the transport stream TS. Alternatively, the base stream and the dependent stream that include the items of two-dimensional image data that are the same, respectively, are included in the transport stream TS.

The set-top box 200, as described above, performs processing based on the identification information that is inserted into the base stream and the dependent stream and thus obtains the image data in an appropriate, efficient manner. That is, if the first identification information is not included in the base stream, only the base stream is decoded, and thus the two-dimensional image data is obtained. FIG. 2(c) schematically illustrates processing by the broadcasting station 100 and processing by the set-top box 200 in this case. In this case, the two-dimensional image data that corresponds to 2D content is encoded with AVC and thus is transmitted from the transmitting side. At the receiving side, decoding is performed with AVC, and thus the two-dimensional image data is obtained.

Furthermore, if the first identification information is included in the base stream and the second identification information that is included in the dependent stream indicates the stereoscopic image transmission mode, both the base stream and the dependent stream are decoded, and thus the items of image data on the left eye view and the right eye view are obtained. FIG. 2(a) schematically illustrates processing by the broadcasting station 100 and processing by the set-top box 200 in this case. In this case, the items of image data on the left eye view and the right eye view that correspond to 3D content are encoded with MVC and are transmitted from the transmitting side. At the receiving side, the decoding is performed with MVC, and the items of image data on the left eye view and the right eye view are obtained.

Furthermore, if the first identification information is included in the base stream and the second identification information that is included in the dependent stream indicates the two-dimensional image transmission mode, only the base stream is decoded and thus display image data for displaying a two-dimensional image is obtained. FIG. 2(b) schematically illustrates processing by the broadcasting station 100 and processing by the set-top box 200 in this case. In this case, the two-dimensional image data that corresponds to the 2D content is encoded with MVC and thus is transmitted from the transmitting side. At the receiving side, the decoding is performed with MVC, and the two-dimensional image data is obtained. In this case, only the base stream is decoded.

The set-top box 200 transfers (transmits) the image data obtained as described above to the television receiver 300 through an HDMI digital interface. At this point, the set-top box 200 makes up an HDMI source apparatus, and the television receiver 300 makes up an HDMI sink apparatus.

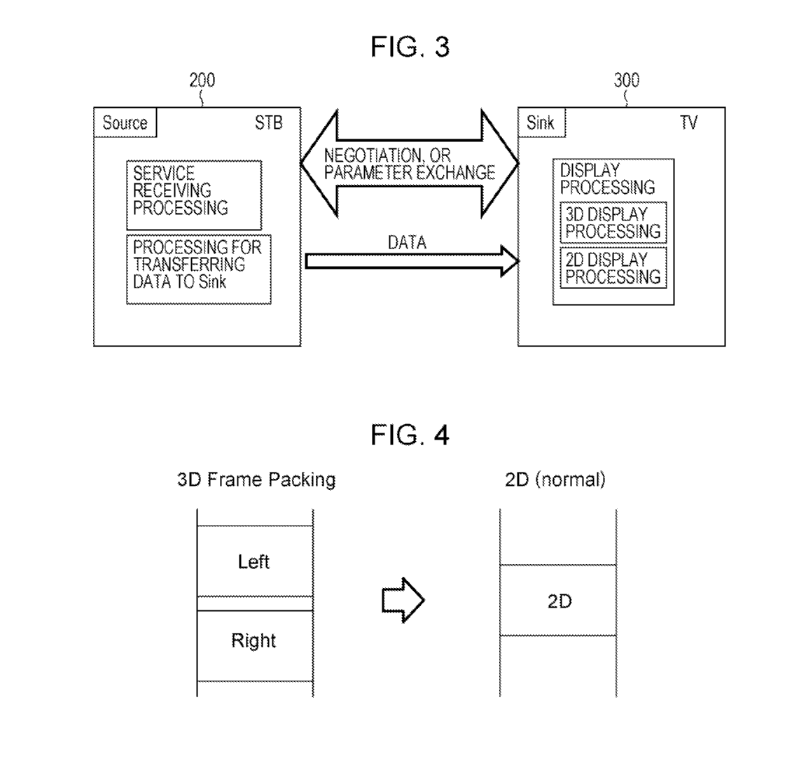

The set-top box 200, as illustrated in FIG. 3, performs processing that receives a service and performs digital transfer processing that transfers data to the television receiver 300. Furthermore, the television receiver 300, as illustrated in FIG. 3, performs 3D display processing or 2D display processing according to the image data that is transmitted from the set-top box 200. A change in a format parameter of the digital interface occurs between the set-top box 200 and the television receiver 300.

At this point, as illustrated in FIG. 4, a case is considered in which stereoscopic image data (the items of image data on the left eye (left) view and the right eye (right) view that make up the stereoscopic image) is transmitted in a stereoscopic image transfer format, for example, “3D Frame Packing” and the two-dimensional image data is transmitted in a two-dimensional image transfer format, for example, “2D (Normal).”

In this case, when switching is performed from the stereoscopic image data to the two-dimensional image data, a time lag due to the change in the format parameter between the set-top box 200 and the television receiver 300 occurs during a period of time from a point in time of switching to the time when the image data is actually transmitted. Thus, there is a likelihood that a non-display interval (mute interval) will occur in the television receiver 300.

Accordingly, according to the present technology, the same transfer format is used when transmitting the two-dimensional image data as when transmitting the stereoscopic image data. According to the embodiment, the transfer format of “3D Frame Packing,” is also used when transmitting the stereoscopic image data and when transmitting the two-dimensional image data. Of course, other stereoscopic image transfer formats may be used.

[Case where the Stereoscopic Image Data is Transmitted]

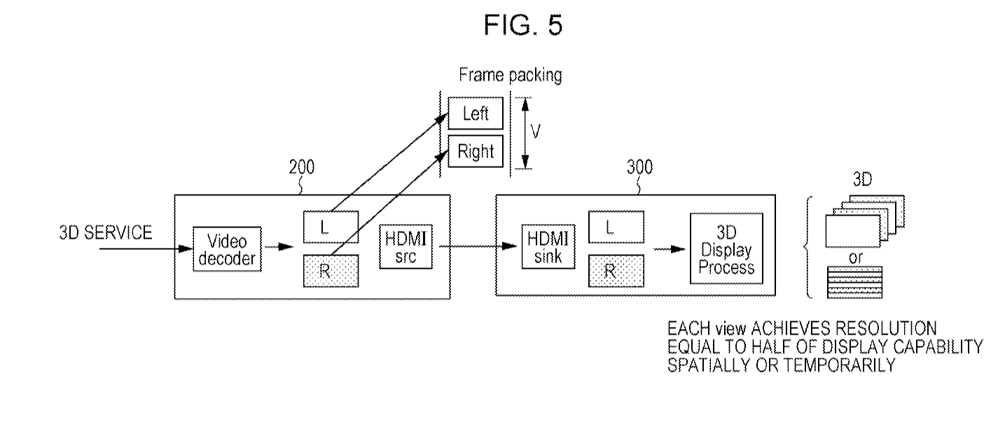

A case where the stereoscopic image data (the items of image data on the left eye view and the right eye view that make up the stereoscopic image) is transmitted is described. FIG. 5 schematically illustrates examples of the processing by the set-top box 200 at the transmitting side and of the processing by the television receiver 300 at the receiving side in the case where the stereoscopic image data is transmitted.

In the set-top box 200, the video stream is decoded and, thus the stereoscopic image data, that is, the items of image data on the left eye view and the right eye view are obtained (refer to FIG. 2(a)) and the image data on each view is transmitted in the transfer format of “3D Frame Packing.” Furthermore, in the television receiver 300, the 3D display processing is performed on the image data on each view, and thus, the display image data for displaying a 3D image is obtained. In this case, the image displaying of each view is made to have a resolution that is equal to half of the display capability spatially and temporally.

[Case where the Two-Dimensional Image Data is Transmitted]

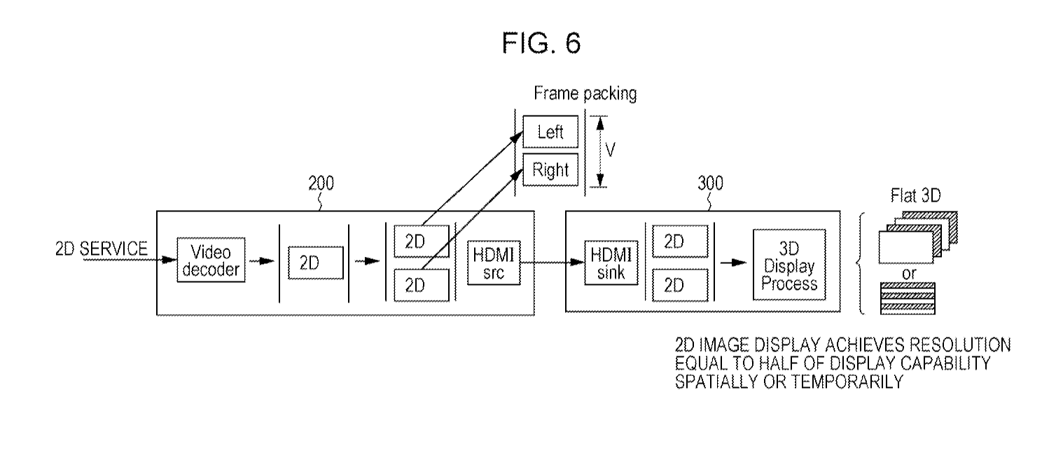

Next, a case where the two-dimensional image data is transmitted is described. FIG. 6 schematically illustrates examples of the processing by the set-top box 200 at the transmitting side and of the processing by the television receiver 300 at the receiving side in the case where the two-dimensional image data is transmitted. The processing example is an example in which the two-dimensional image data is transmitted in the transfer format of “3D Frame Packing,” but the same two-dimensional image data is simply inserted into each insertion portion of the items of image data on the left eye view and the right eye view and thus is transmitted.

In the set-top box 200, the video stream is decoded, and thus the two-dimensional image data is obtained (refer to FIGS. 2(b) and 2(c)), and the two-dimensional image data is transmitted in the transfer format of “3D Frame Packing.” In this case, the same two-dimensional image data is inserted into each of the insertion portions of the items of image data on the left eye view and the right eye view.

Furthermore, in the television receiver 300, the 3D display processing is performed on the items of two-dimensional image data that are the same, and the display image data is generated. The display image data is set in such a manner that the same image frames in the time direction progress two at a time or the same lines in the vertical direction progress two at a time within a frame. In this case, the flat 3D display becomes present, and the image displaying of each view is made to have a resolution that is equal to half of the display capability spatially or temporally.

Accordingly, according to the present technology, when transmitting the two-dimensional image data in the transfer format of “3D Frame Packing”, the following (1) or (2) is simply applied without inserting the same two-dimensional image data into each of the insertion portions of the items of image data on the left eye view and the right eye view.

[(1) Reformatting of the Two-Dimensional Image Data]

The two-dimensional image data is reformatted, and first image data and second image data that have to be inserted into the insertion portions, respectively, of the items of image data on the left eye view and the right eye view are generated. Then, when transmitting the two-dimensional image data in the transfer format of “3D Frame Packing,” the first image data and the second image data are inserted into the insertion portions, respectively, of the items of image data on the left eye view and the right eye view.

At this point, the reformatting of the two-dimensional image data is performed in such a manner as to correspond to a stereoscopic display method employed in the television receiver 300. The set-top box 200 can obtain various pieces of information from an enhanced extended display identification data (EDID) register (EDID-ROM) of the television receiver 300. Such pieces of information include pieces of information on a format type that is receivable, a monitor size, and a stereoscopic display method (a polarization method, a shutter method, and the like).

When the stereoscopic display method is a polarization method, the set-top box 200 divides the two-dimensional image data into image data in even lines and image data in odd lines, configures the first image data from the image data in the even lines, and configures the second image data from the image data in the odd lines.

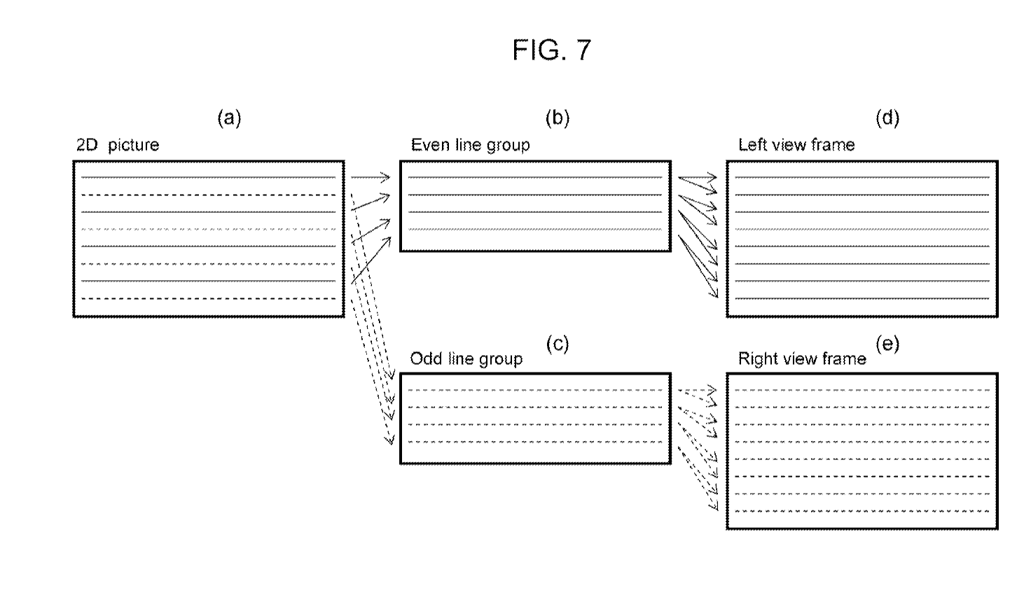

FIG. 7 illustrates one example of processing that generates the first image data and the second image data from the two-dimensional image data. FIG. 7(a) illustrates the two-dimensional image data. The two-dimensional image data, as illustrated in FIGS. 7(b) and 7(c), is divided, in the vertical direction, into an even line group and an odd line group.

Then, as illustrated in FIG. 7(d), processing, such as line double-writing is performed on the image data in the even lines, and thus the number of lines is made to be in accordance with the original two-dimensional image data. As a result, the first image data (a left view frame) that is inserted into the portion of the image data on the left eye view is obtained. Furthermore, as illustrated in FIG. 7(e), the processing, such as the line double-writing is performed on the image data in the odd lines, and thus the number of lines is made to be in accordance with the original two-dimensional image data. As a result, the second image data (a right view frame) that is inserted into the portion of the image data on the right eye view is obtained.

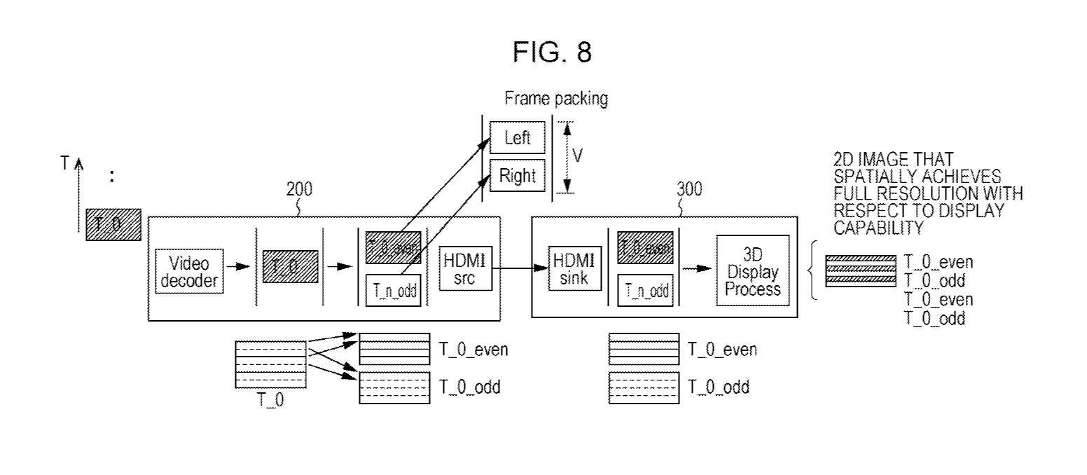

FIG. 8 schematically illustrates examples of the processing by the set-top box 200 at the transmitting side and of the processing by the television receiver 300 at the receiving side if the 3D display method is the polarization method in a case where the two-dimensional image data is reformatted and thus is transmitted.

In the set-top box 200, the video stream is decoded and thus two-dimensional image data is obtained (refer to FIGS. 2(b) and 2(c)). The two-dimensional image data is transmitted in the transfer format of “3D Frame Packing.” Now, two-dimensional image data T_{—}0 is divided into even and odd groups, and thereafter the processing, such as the line double-writing is performed on each of the even and odd groups, and thus the number of lines in each of the even and odd groups is made to be in accordance with the original two-dimensional image data T_{—}0. Accordingly, first image data (left view frame) T_{—}0 even that is inserted into the portion of the image data on the left eye view is obtained (refer to FIG. 7(d)). Furthermore, second image data (right view frame) T_{—}0_odd that is inserted into the portion of the image data on the right eye view is obtained (refer to FIG. 7(e)).

Furthermore, in the television receiver 300, 3D display processing using the polarization method is performed on the first image data and the second image data, and thus the display image data is generated. The display image data is obtained by extracting lines from the first image data and the second image data alternately in the vertical direction, and is made to correspond to the original two-dimensional image data T_{—}0. In this case, display of the two-dimensional image is made to spatially achieve a full resolution in the vertical direction with respect to the display capability.

Moreover, the example is described above in which the two-dimensional image data is divided, in the vertical direction, into the even line group and the odd line group and thus the first image data and the second image data are generated. However, it is considered that the two-dimensional image data may be divided, in the horizontal direction, into the even line group and the odd line group and thus the first image data and the second image data are generated. Whether the two-dimensional image data is divided in the vertical direction or in the horizontal direction depends on whether the 3D display method is the polarization method.

Furthermore, when the stereoscopic display method is the shutter method, the set-top box 200 configures each frame of the first image data from each frame of the two-dimensional image data and configures each frame of the second image data from an interpolation frame between each frame of the two-dimensional image data.

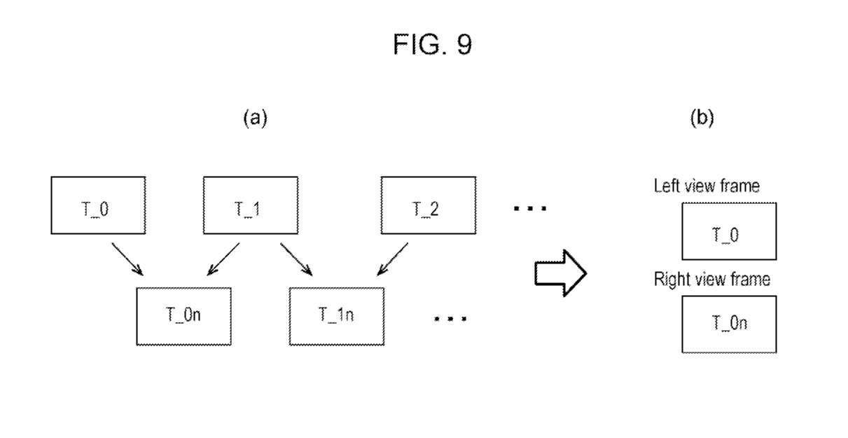

FIG. 9 illustrates one example of processing that generates the first image data and the second image data from the two-dimensional image data. In FIG. 9(a), T_{—}0, T_{—}1, T_{—}2, and so forth indicate successive frames for the two-dimensional image data. Furthermore, in FIG. 9(a), T_{—}0n, T_{—}1n, and so forth indicate successive interpolation frames between each frame of the two-dimensional image data. At this point, the interpolation frame T_{—}0n is generated from the frames T_{—}0 and T_{—}1 for the two-dimensional image data, and the interpolation frame T_{—}1n is generated from the frames T_{—}1 and T_{—}2 for the two-dimensional image data. Then, as illustrated in FIG. 9(b), each frame of the two-dimensional image data is set to be each frame of the first image data (the left view frame). Furthermore, as illustrated in FIG. 9(b), each interpolation frame is set to be each frame of the second image data (the right view frame).

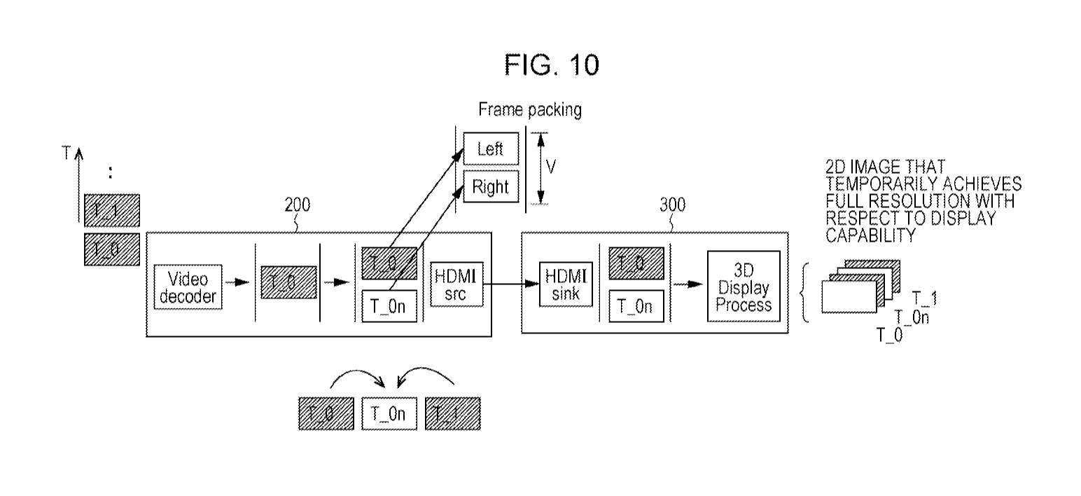

FIG. 10 schematically illustrates examples of the processing by the set-top box 200 at the transmitting side and of the processing by the television receiver 300 at the receiving side if the 3D display method is the shutter method in a case where the two-dimensional image data is reformatted and is transmitted.

In the set-top box 200, the video stream is decoded and thus two-dimensional image data is obtained (refer to FIGS. 2(b) and 2(c)). The two-dimensional image data is transmitted in the transfer format of “3D Frame Packing.” Now, the interpolation frame between each frame is generated from each frame of the two-dimensional image data. Then, the frame T_{—}0 for the two-dimensional image data is set to be the first image data (the left view frame) that is inserted into the portion of the image data on the left eye view (refer to FIG. 9(b)). Furthermore, the interpolation frame T_{—}0n is set to be the second image data (the right view frame) that is inserted into the portion of the image data on the right eye view (refer to FIG. 9(b)).

Furthermore, in the television receiver 300, 3D display processing using the shutter method is performed on the first image data and the second image data, and thus the display image data is generated. The display image data is obtained by placing the frame of the first image data and the frame of the second image data alternately side by side, and becomes equal to that obtained when interpolation processing for N-times speed display is performed on the original two-dimensional image data. In this case, the display of the two-dimensional image is made to spatially achieve a full resolution with respect to the display capability, and is made to be smoother display for motion.

[(2) Transmission of the Identification Information Indicating the Presence of the Two-Dimensional Image Data]

The two-dimensional image data itself is set to be the first image data and the second image data that have to be inserted into the insertion portions, respectively, of the items of image data on the left eye view and the right eye view. Then, when transmitting the two-dimensional image data in the transfer format of “3D Frame Packing,” the same two-dimensional image data is inserted into each of the insertion portions of the items of image data on the left eye view and the right eye view. In this case, the identification information indicating that the first image data and the second image data are the items of two-dimensional image data that are the same is also transmitted.

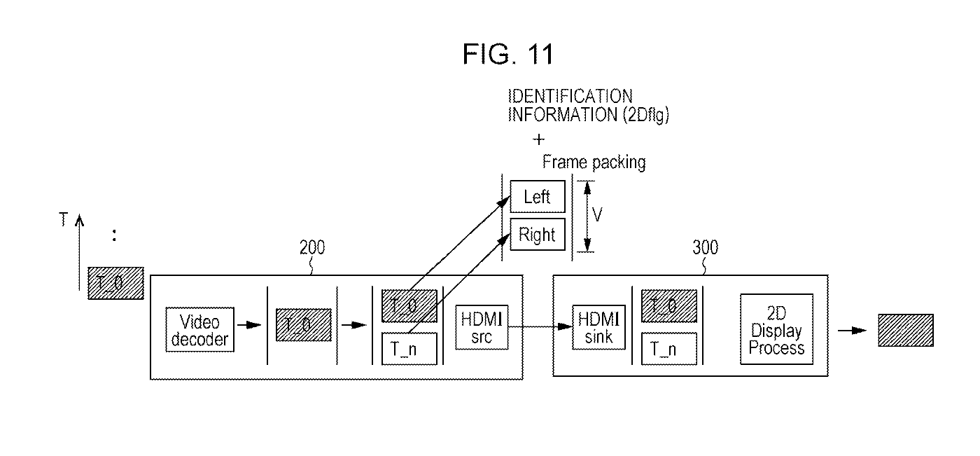

FIG. 11 schematically illustrates examples of the processing by the set-top box 200 at the transmitting side and of the processing by the television receiver 300 at the receiving side in the case where the two-dimensional image data is transmitted. In the set-top box 200, the video stream is decoded and thus two-dimensional image data is obtained (refer to FIGS. 2(b) and 2(c)). The two-dimensional image data is transmitted in the transfer format of “3D Frame Packing.”

In this case, the two-dimensional image data T_{—}0 is set to be the first image data (the left view frame) that is inserted into the portion of the image data on the left eye view. Furthermore, a copy T_n of the two-dimensional image data T_{—}0 is set to be the second image data (the right view frame) that is inserted into the portion of the image data on the right eye view. Then, in this case, identification information (2Dflg) indicating that the first image data and the second image data are the items of two-dimensional image data that are the same is added to the image data and thus is transmitted.

Furthermore, in the television receiver 300, based on the identification information, the 2D display processing is performed on one of the first image data and the second image data, and thus the display image data is generated. In this case, because view interleaving does not occur, a 2D image that has a full resolution is displayed.

Moreover, the set-top box 200 transmits to the television receiver 300 message information suggesting that the user of the television receiver 300 should perform a specific viewing action, according to which one of the stereoscopic image data (the items of image data on the left eye view and the right eye view that make up the stereoscopic image) and the two-dimensional image is transmitted. For example, the message information suggests that the user should wear his/her 3D glasses (polarized glasses, shutter glasses, and the like) at the time of the transmission of the stereoscopic image data and suggests that the user should take off his/her 3D glasses at the time of the transmission of the two-dimensional image data. Based on the message information, the television receiver 300 displays the message on a display image in such a manner as to superimpose the message onto the display image and suggests that the user should perform a specific viewing action.

[Configuration Example of Transmission-Data Generation Unit]

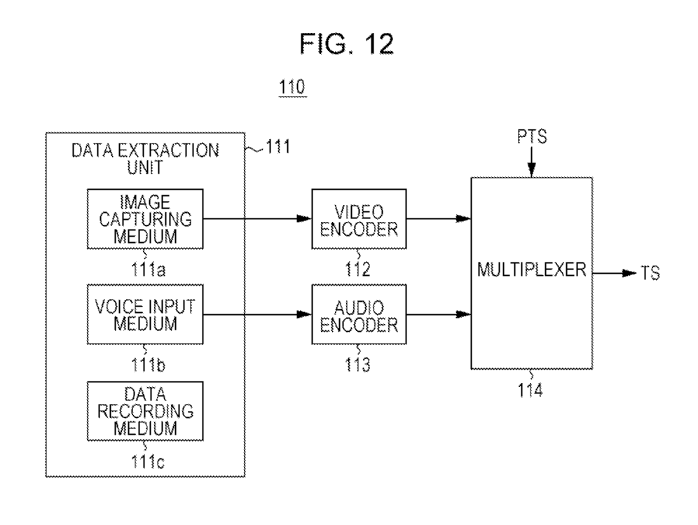

FIG. 12 illustrates a configuration example of a transmission-data generation unit 110 that generates the transport stream TS described above in the broadcasting station 100. The transmission-data generation unit 110 has a data extraction unit 111, a video encoder 112, an audio encoder 113, and a multiplexer 114.

The data extraction unit 111 has an image capturing medium 111a, a voice input medium 111b, and a data recording medium 111c. The image capturing medium 111a is a camera that images a photographic subject and thus outputs items of data on a left eye image and a right eye image that make up the stereoscopic image, or the two-dimensional image data. The voice input medium 111b is a microphone that outputs voice data. Furthermore, the data recording medium 111c records and reproduces each item of data described above.

The video encoder 112 performs coding, for example, MPEG4-AVC (MVC), MPEG2 video, or HEVC, on the image data that is extracted from the data extraction unit 111 and thus obtains the coded image data. Furthermore, the video encoder 112 generates the video stream (a video elementary stream) that includes the coded image data using a stream formatter (not illustrated) provided on the rear side.

The video encoder 112 becomes in the stereoscopic (3D) image transmission mode or the two-dimensional (2D) image transmission mode in a unit of an event (a program). In the stereoscopic image transmission mode in which a 3D content image is transmitted, the video encoder 112 generates the base stream and the dependent stream that include the items of image data on a base view and a non-base view, respectively, that make up the stereoscopic image. Furthermore, in the two-dimensional image transmission mode in which a 2D content image is transmitted, the video encoder 112 generates only the base stream that includes the two-dimensional image data or generates the base stream and the dependent stream that include the items of two-dimensional image data, respectively.

If the base stream and the dependent stream are included in the transport stream TS, the video encoder 112 inserts into the base stream the first identification information (the 3D signaling) indicating the presence of the dependent stream other than the base stream. Furthermore, if the dependent stream other than the base stream is included in the transport stream TS, the video encoder 112 inserts into the dependent stream the second identification information identifying which one of the stereoscopic image transmission mode and the two-dimensional image transmission mode is present.

The audio encoder 113 performs the coding, such as MPEG-2 Audio or AAC, on the voice data that is extracted from the data extraction unit 111 and generates an audio stream (an audio elementary stream).

The multiplexer 114 multiplexes each stream from the video encoder 112 and the audio encoder 113 and obtains the transport stream TS. In this case, a presentation time stamp (PTS) or a decoding time stamp (DTS) is inserted into a header of each packetized elementary stream (PES) for synchronous reproduction at the receiving side.

The multiplexer 114 inserts into the layer of the transport stream TS the third identification information indicating which one of the stereoscopic image transmission mode and the two-dimensional image transmission mode is present. A message suggesting that a user should perform a specific viewing action is added to the identification information, corresponding to the transmission mode.

Operation of the transmission-data generation unit 110 illustrated in FIG. 12 is briefly described. The image data (the items of data on the left eye image and the right eye image that make up the stereoscopic image, or the two-dimensional image) that is extracted from the data extraction unit 111 is supplied to the video encoder 112. In the video encoder 112, the coding is performed on the image data, and thus the video stream (the video elementary stream) including the coded image data is generated. The video stream is supplied to the multiplexer 114.

In this case, in the stereoscopic image transmission mode in which the 3D content image is transmitted, the base stream and the dependent stream are generated that include the items of image data on the base view and the non-base view, respectively, that make up the stereoscopic image. Furthermore, in this case, in the two-dimensional image transmission mode in which the 2D content image is transmitted, only the base stream that includes the two-dimensional image data is generated, or the base stream and the dependent stream that include the items of two-dimensional image data, respectively, are generated.

Furthermore, if the base stream and the dependent stream are generated, in the video encoder 112, processing is performed that inserts into the base stream the first identification information (the 3D signaling) indicating the presence of the dependent stream other than the base stream. Furthermore, if the dependent stream and the base stream are generated, in the video encoder 112, processing is performed that inserts into the dependent stream the second identification information identifying which one of the stereoscopic image transmission mode and the two-dimensional image transmission mode is present.

The voice data that is extracted from the data extraction unit 111 is supplied to the audio encoder 113. In the audio encoder 113, the coding is performed on the voice data, and the audio stream (the audio elementary stream) is generated. The audio stream is supplied to the multiplexer 114.

In the multiplexer 114, each stream from the video encoder 112 and the audio encoder 113 is multiplexed, and the transport stream TS is generated. In this case, the PTS is inserted into a PES header for the synchronous reproduction at the receiving side. Furthermore, in the multiplexer 114, the third identification information indicating which one of the stereoscopic image transmission mode and the two-dimensional image transmission mode is present is inserted into the layer of the transport stream TS.

[Syntax and TS Configuration of Various Items of Identification Information]

As described above, if the base stream and the dependent stream are included in the transport stream TS, the first identification information (3D signaling) identifying the presence of the dependent stream other than the base stream is inserted into the base stream. For example, if a coding method is MPEG4-AVC (MVC), or if the coding method is one like HEVC, that is similar in coding structure, such as a NAL unit, the first identification information is inserted, as an SEI message, into an “SEIs” portion of an access unit (AU).

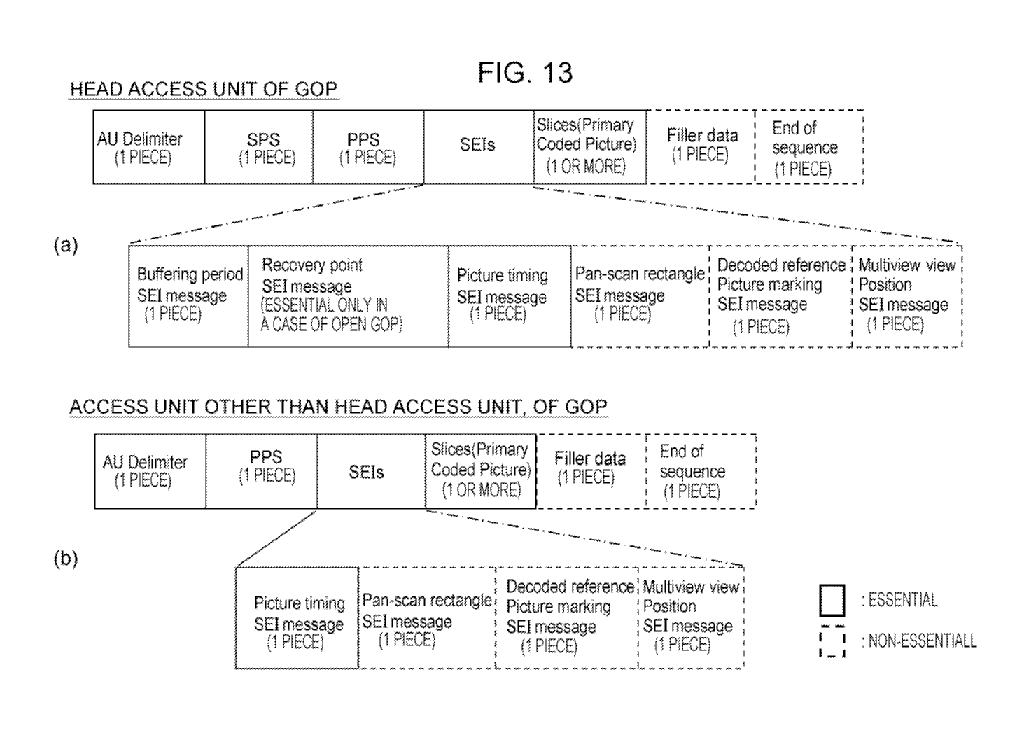

In this case, for example, an existing multiview_view_position SEI message is used as the first identification information. FIG. 13(a) illustrates a head access unit of a group of pictures (GOP). FIG. 13(b) illustrates an access unit other than the head access unit, of the GOP. Because the SEI message is coded in a preceding position on a bit stream than slices in which pixel data is coded, it is possible for the receiver to determine subsequent decoding processing, by identifying semantics of SEI.

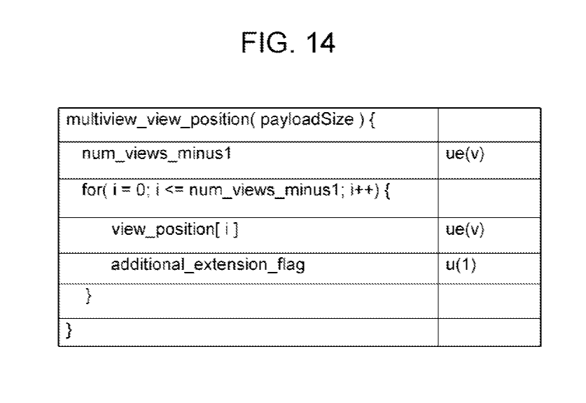

FIG. 14 illustrates a syntax of multiview view position( ) that is included in the SEI message. A field “num_views_minus1” indicates values (0 to 1023) that result from subtracting 1 from the number of bits. A field “view_position [i]” indicates a relative positional relationship at the time of the display of each view. That is, the field “view_position [i]” indicates sequential relative positions from a left view to a right view at the time of the display of each view using values that sequentially increase from 0.

Furthermore, as described above, if the dependent stream other than the base stream is included in the transport stream TS, the second identification information (the 2D/3D signaling) identifying which one of the stereoscopic image transmission mode and the two-dimensional image transmission mode is present is inserted into the dependent stream. For example, if the coding method is MPEG4-AVC (MVC), or if the coding method is one like HEVC, that is similar in coding structure, such as the NAL unit, the second identification information is inserted into a header portion of the NAL unit that makes up the dependent stream.

Specifically, the inserting of the second identification information is performed by defining a relationship with the base stream in a field “priority_id” in “NAL unit header mvc extension” of the NAL unit that makes up the dependent stream.

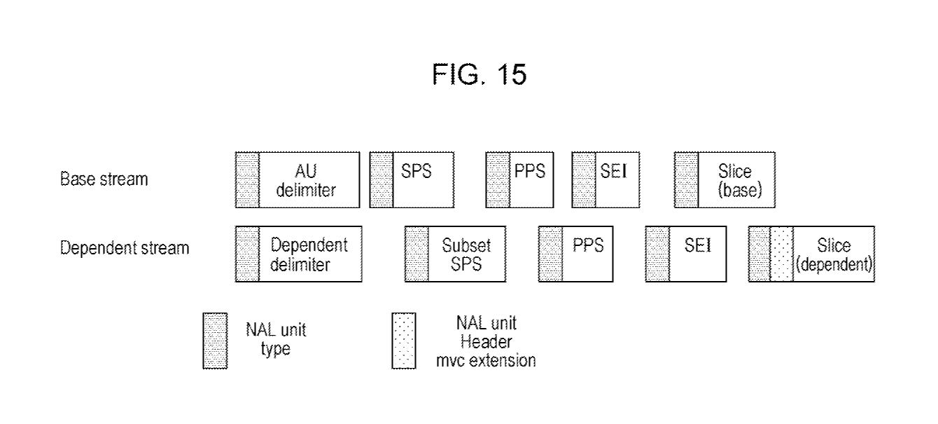

FIG. 15 schematically illustrates a configuration of the base stream and the dependent stream that are coded in a structure of the NAL unit. The access unit (AU) of the base stream is configured from the NAL unit including “AU delimiter,” “SPS,” “PPS,” “SEI,” “slice (base),” and so forth. The “AU delimiter” indicates starting of the access unit. The “SPS” indicates a sequence parameter. The “PPS” indicates a picture parameter. The “SEI” provides information that is useful in terms of display or buffer management. The “slice(base)” includes coded data on an actual picture.

Moreover, only one “SEI” is illustrated, but actually, multiple “SEI's” are present. Only one multiview_view_position SEI message described above is illustrated, but actually, multiple multiview_view_position SEI messages are present. Furthermore, “SPS” is present only in the head access unit of the group of pictures (GOP).

The access unit (AU) of the dependent stream is configured from the NAL unit including “dependent delimiter,” “subset SPS,” “PPS,” “SEI,” “slice(dependent),” and so forth. The “dependent delimiter” indicates starting of the access unit. The “subset SPS” indicates the sequence parameter. The “PPS” indicates the picture parameter. The “SEI” provides the information that is useful in terms of display or buffer management. The “slice (dependent)” includes the coded data on the actual picture.

The NAL unit of the base stream is made from the head “NAL unit type” and “NAL unit payload” that follows the head “NAL unit type.” In contrast, in the NAL unit of the dependent stream, “NAL unit header mvc extension” is present between “NAL unit type” and “NAL unit payload.”

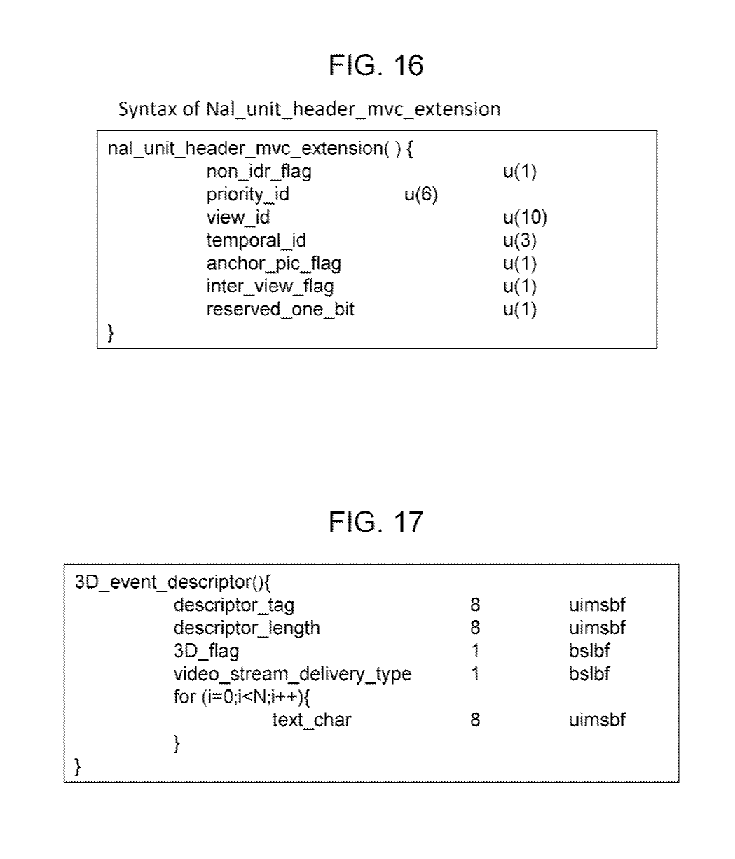

FIG. 16 illustrates a syntax of “NAL unit header mvc extension.” As illustrated in the drawings, “priority_id” is present in the “NAL unit header mvc extension.” “Priority_id” means that the smaller the value, the higher the priority, and that conversely, the greater the value, the lower the priority.

According to the embodiment, if this meaning assignment is applied and the same two-dimensional image data is included in both the base stream and the dependent stream, there is no data independence in the dependent stream and therefore the lowest priority is given. Thus, this is set to mean that there is no need for display and is set to be the signaling that means the interpretation as the two-dimensional image transmission mode. That is, if the value in “priority_id” is great, namely, “0×3E,” this means that 2D (the two-dimensional image transmission mode) that is significantly low in priority is present.

On the other hand, in the case of 3D (the stereoscopic image transmission mode), the dependent stream has view data separate from the base stream. Because of this, in order to mean that data independence is retained, a value is set to be higher in priority than for 2D, that is, to be greater than “0×00” but smaller than “0×3E.”

From the value in “priority_id,” it can be identified whether or not the coded data (base slice) in the base stream and the coded data (dependent slice) in the dependent stream are the same, and therefore it can be identified which one of 2D (the two-dimensional image transmission mode) and 3D (the stereoscopic image transmission mode) is present. According to the present embodiment, the following identification is possible.

That is, when “priority_id=0×01 to 0×3E,” “dependent slice≠base slice,” and 3D (the stereoscopic image transmission mode) is identified as being present. Furthermore, when “priority_id=0×3E,” “dependent slice=base slice” and 2D (the two-dimensional image transmission mode) is identified as being present.

Moreover, because “priority_id” is synchronized with “slice” and thus can be switched, “priority_id” is set to be the 3D/2D signaling to be frame-accurate. Furthermore, signaling information is put into all “NAL unit Header MVC extensions” in such a manner that the receiver can perform detection at any timing.

The base stream does not retain “nal_unit_header_mvc_extension,” but “slice (base)” thereof is determined to be regarded as “priority_id=0×00” (the highest priority). “Priority_id” is not used in a decode process as MPEG standards, but can be used in applications.

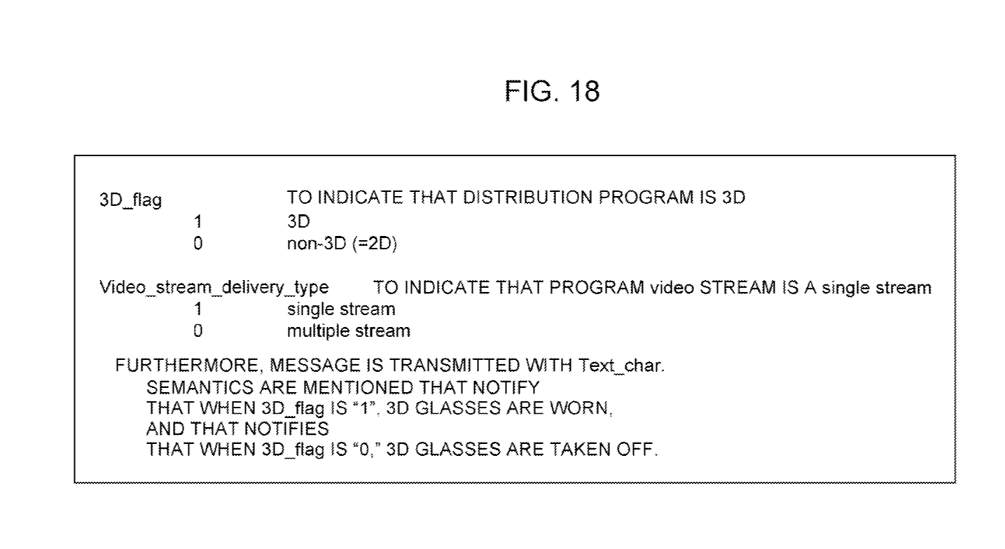

Furthermore, as described above, the third identification information indicating which one of the stereoscopic image transmission mode and the two-dimensional image transmission mode is present is inserted into a level below the event information table that is included in the transport stream TS. FIG. 17 illustrates a syntax of 3D_event_descriptor as the third identification information. Furthermore, FIG. 18 illustrates semantics of important information in the syntax.

An 8-bit field, “descriptor_tag” indicates a descriptor type and here indicates the presence of a 3D event descriptor. An 8-bit field, “descriptor_length” indicates a length (a size) of a descriptor and indicates the number of subsequent bytes as the length of the descriptor.

Flag information, “3D_flag,” indicates whether or not a distribution program (an event) is of 3D. “1” indicates 3D, and “0” indicates that there is no 3D, that is, indicates 2D. A 1-bit field, “video_stream_delivery_type” indicates whether or not a stream of video of a program is a single stream. “1” indicates the presence of the single stream, and “0” indicates the presence of multiple streams.

Furthermore, in the 3D event descriptor, a message is transmitted with “text_char.” The message is, for example, a message suggesting that the user should perform a specific viewing action. In this case, semantics may be mentioned that notify that when “3D_flag” is “1,” the 3D glasses should be worn. Conversely, semantics may be mentioned that notify that when “3D_flag” is “0,” the 3D glasses should be taken off.

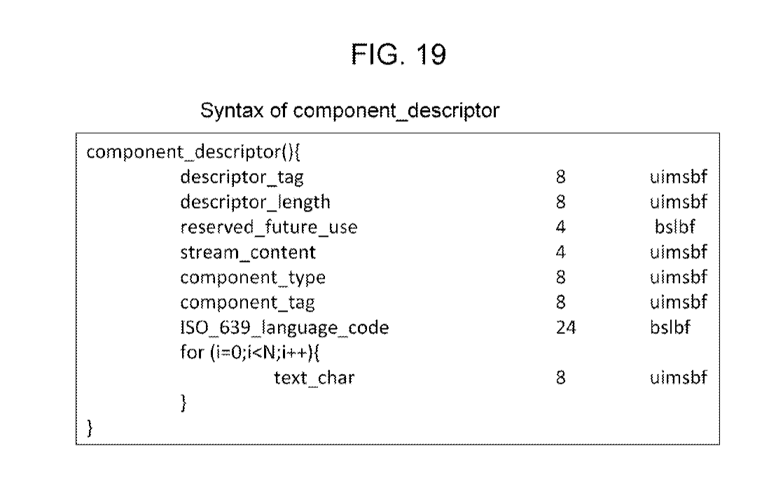

Moreover, instead of the 3D event descriptor, an application can be made to the existing component descriptor that is inserted into a level below the event information table. FIG. 19 illustrates a syntax of the component descriptor. A 4-bit field, “stream_content” indicates types of formats (MPEG-4-AVC, MVC, and so forth) to transfer. Furthermore, an 8-bit field, “component_type” indicates 2D or 3D (in a case of 3D, frame-compatibility or service-compatibility).

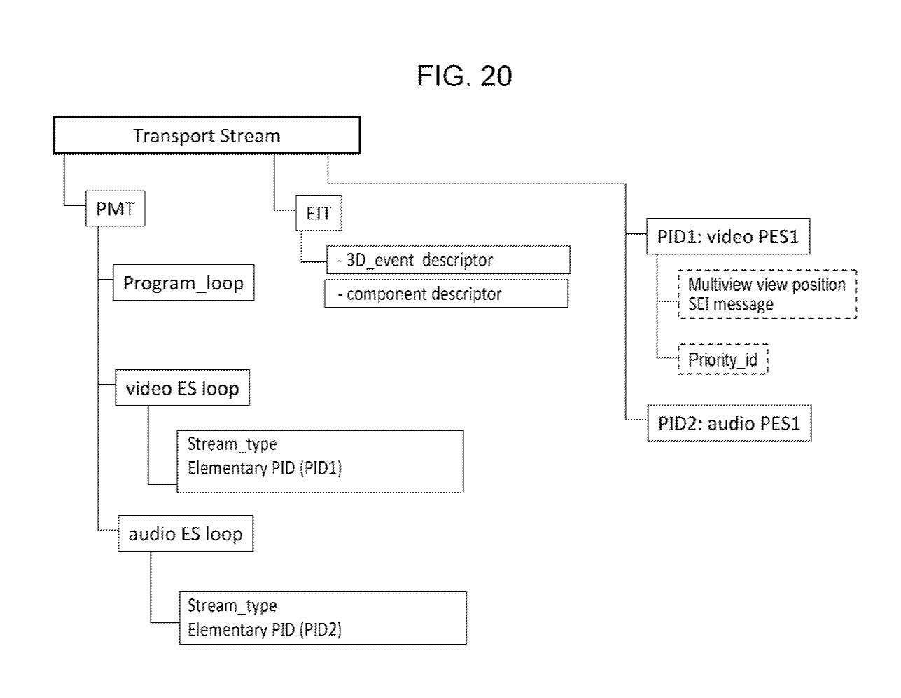

FIG. 20 illustrates a configuration example of the transport stream TS. A PES packet “PID1: video PES1” of the video elementary stream and a PES packet “PID2: audio PES1” are included in the transport stream TS.

If the dependent stream other than the base stream is included in the video elementary stream, the first identification information (the 3D signaling) indicating the presence of the dependent stream other than the base stream is inserted, as a multiview view position SEI message, into the base stream.

Furthermore, if the dependent stream other than the base stream is included in the video elementary stream, the second identification information (the 2D/3D signaling) identifying which one of the stereoscopic image transmission mode and the two-dimensional image transmission mode is present is inserted into the field “priority_id” of “NAL unit header mvc extension” of the NAL unit of the dependent stream.

Furthermore, a program map table (PMT) is included, as program specific information (PSI), in the transport stream TS. The PSI is information in which, which program each elementary stream included in the transport stream belongs to is written. Furthermore, an event information table (EIT) is included, as serviced information (SI) that performs managing in a unit of an event (a program), in the transport stream TS.

An elementary loop that retains information relating to each elementary stream is present in the PMT. A video elementary loop (a video ES loop) is present in the configuration example. Corresponding to one video elementary stream described above, information, such as a streaming type and a packet identifier (PID) is arranged in the video elementary loop, and the descriptor that describes information relating to the video elementary stream thereof is also arranged in the video elementary loop.

The third identification information indicating which one of the stereoscopic image transmission mode and the two-dimensional image transmission mode is present is inserted, as a 3D event descriptor, into a level below the EIT. Furthermore, the component descriptor is also inserted into the level below the EIT.

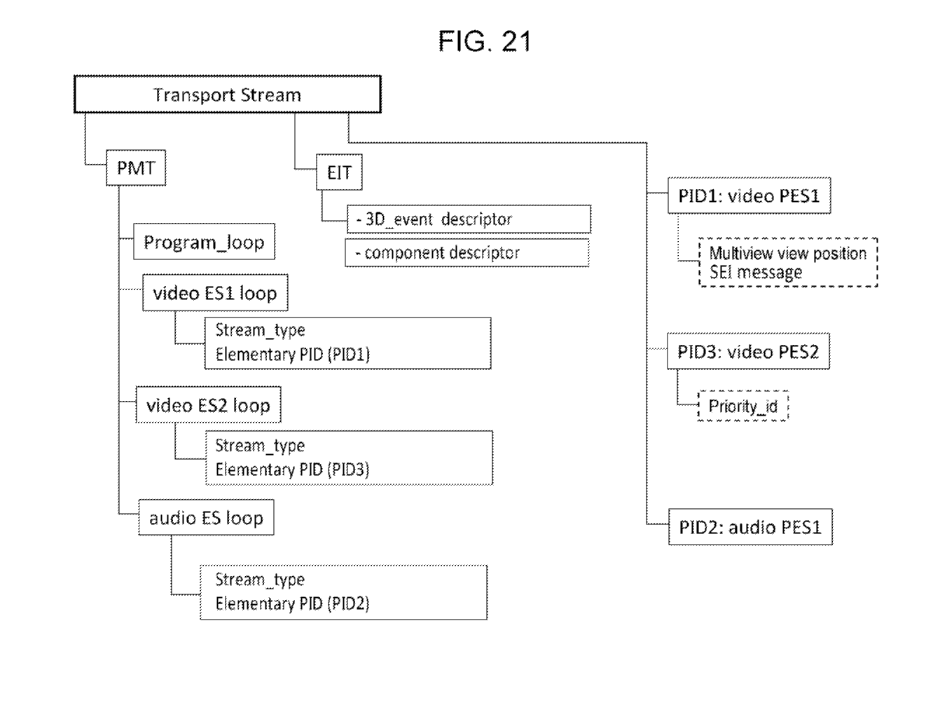

Moreover, the configuration example of the transport stream TS illustrated in FIG. 20 illustrates the case where the base stream and the dependent stream are inserted into the same video elementary stream and thus are transmitted. It is considered that the base stream and the dependent stream are inserted into separate video elementary streams and thus are transmitted. Although not illustrated in detail, FIG. 21 illustrates a configuration example of the transport stream TS in such a case.

[Configuration Example of the Set-Top Box]

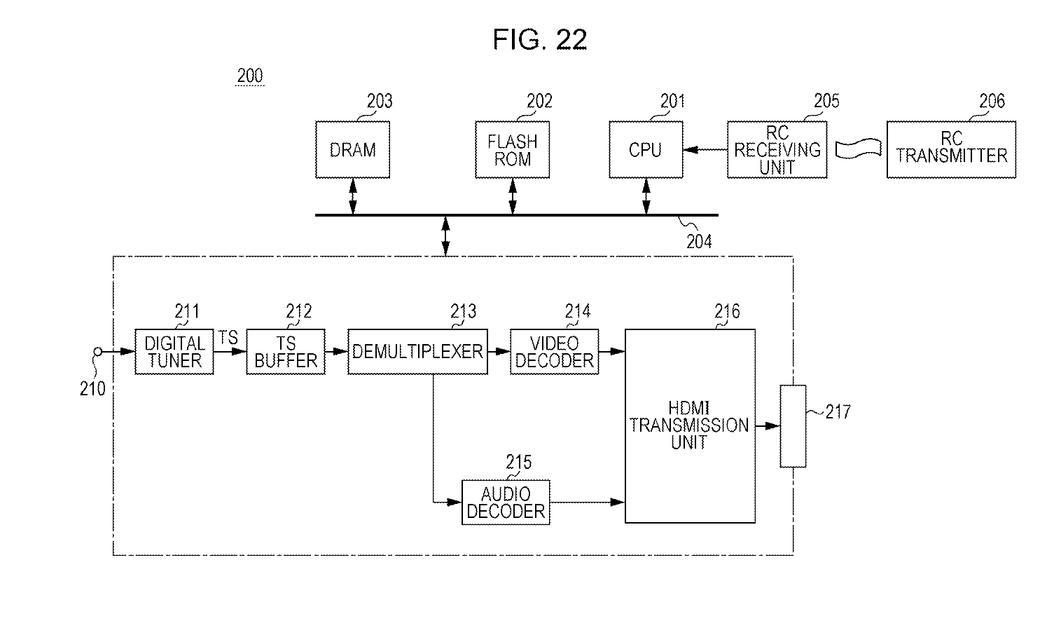

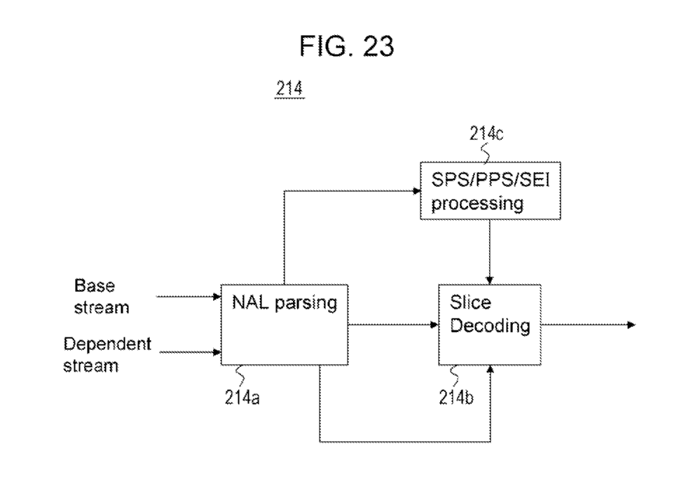

FIG. 22 illustrates a configuration example of the set-top box 200. The set-top box 200 has a CPU 201, a flash ROM 202, a DRAM 203, an internal bus 204, a remote control receiving unit (an RC receiving unit) 205, and a remote control transmitter (an RC transmitter) 206.

Furthermore, the set-top box 200 has an antenna terminal 210, a digital tuner 211, a transport stream buffer (a TS buffer) 212, and a demultiplexer 213. Furthermore, the set-top box 200 has a video decoder 214, an audio decoder 215, an HDMI transmission unit 216, and an HDMI terminal 217.

The CPU 201 controls operation of each unit of the set-top box 200. The flash ROM 202 performs storing of control software and keeping of data. The DRAM 203 makes up a work area of the CPU 201. The CPU 201 deploys software and data that are read from the flash ROM 202, on the DRAM 203 and thus activates the software and controls each unit of the set-top box 200.

The RC receiving unit 205 receives a remote control signal (a remote control code) that is transmitted from the RC transmitter 206 and supplies the received remote control signal to the CPU 201. The CPU 201 controls each unit of the set-top box 200, based on the remote control code. The CPU 201, the flash ROM 202, and the DRAM 203 are connected to one another with the internal bus 204.

The antenna terminal 210 is a terminal into which a television broadcasting signal received in a receiving antenna (not illustrated) is input. The digital tuner 211 processes the television broadcasting signal that is input into the antenna terminal 210 and thus outputs a predetermined transport stream TS that corresponds to a channel selected by the user. The TS buffer 212 temporarily accumulates the transport stream TS that is output from the digital tuner 211. The video elementary stream and the audio elementary stream are included in the transport stream TS.

In the stereoscopic (3D) image transmission mode, the base stream and the dependent stream that include the items of image data on the left eye view and the right eye view, respectively, that make up the stereoscopic image are included in the transport stream TS. Furthermore, in the two-dimensional (2D) image transmission mode, only the base stream including the two-dimensional image data is included. Alternatively, the base stream and the dependent stream that include the items of two-dimensional image data that are the same, respectively, are included.

The demultiplexer 213 extracts each stream (the elementary stream) of video and audio from the transport stream TS that is temporarily accumulated in the TS buffer 212. Furthermore, the demultiplexer 213 extracts 3D_event_descriptor (refer to FIG. 17) described above from the transport stream TS and transmits the extracted 3D_event_descriptor to the CPU 201.

From the 3D event descriptor, the CPU 201 can grasp which one of the stereoscopic image transmission mode and the two-dimensional image transmission mode is present. Furthermore, from the 3D event descriptor, the CPU 201 can obtain the message information suggesting that the user should perform a specific viewing action.

The video decoder 214 performs the decoding processing on the video elementary stream that is extracted in the demultiplexer 213 and thus obtains the image data. That is, in the stereoscopic (3D) image transmission mode, the video decoder 214 obtains the items of image data on the left eye view and the right eye view that make up the stereoscopic image. Furthermore, in the two-dimensional (2D) image transmission mode, the video decoder 214 obtains the two-dimensional image data.

At this point, the video decoder 214 performs the decoding processing, based on the first identification information that is inserted into the base stream and the second identification information that is inserted into the dependent stream. As described above, the first identification information is 3D signaling indicating the presence of the dependent stream other than the base stream. As described above, the second identification information is the 2D/3D signaling indicating which one of the stereoscopic image transmission mode and the two-dimensional image transmission mode is present.

FIG. 23 illustrates a detailed configuration example of the video decoder 214. The video decoder 214 has a NAL unit parsing unit 214a, a slice decoding unit 214b, and an SPS/PPS/SEI processing unit 214c. The NAL unit parsing unit 214a parses the NAL units of the base stream and the dependent stream, and transmits the NAL unit of the slice to the slice decoding unit 214b and transmits the NAL units of SPS/PPS/SEI to the SPS/PPS/SEI processing unit 214c.

The slice decoding unit 214b decodes the coded data that is included in the NAL unit of the slice and thus obtains the image data. The NAL unit parsing unit 214a checks semantics of the second identification information (priority_id) that is inserted into the dependent stream and transmits the result of the checking to the slice decoding unit 214b. Furthermore, the SPS/PPS/SEI processing unit 214c checks the presence of the first identification information (multiview view position SEI) in the base stream and transmits the result of the checking to the slice decoding unit 214b.

The slice decoding unit 214b switches the processing, based on the result of each checking. That is, if the first identification information is not included in the base stream, the slice decoding unit 214b decodes only the base stream and thus obtains the two-dimensional image data.

Furthermore, if the first identification information is included in the base stream and the second identification information that is included in the dependent stream indicates the stereoscopic image transmission mode, the slice decoding unit 214b decodes both the base stream and the dependent stream and thus obtains the items of image data on the left eye view and the right eye view that make up the stereoscopic image.

Furthermore, if the first identification information is included in the base stream and the second identification information that is included in the dependent stream indicates the two-dimensional image transmission mode, the slice decoding unit 214b decodes only the base stream and thus obtains the two-dimensional image data.

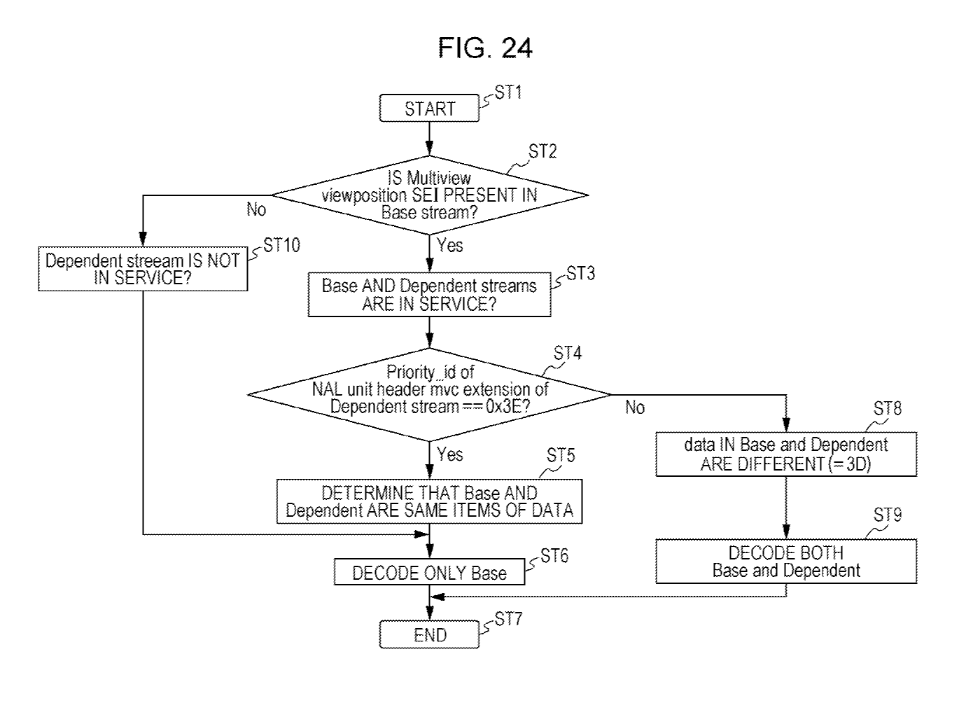

A flow chart in FIG. 24 illustrates one example of a procedure for processing by the video decoder 214. The video decoder 214 starts the processing in Step ST1. Then, in Step ST2, the video decoder 214 determines whether the first identification information (multiview view position SEI) is present in the base stream.

When multiview view position SEI is present, in Step ST3, the video decoder 214 sets the base stream and the dependent stream to be in service. Then, in Step ST4, the video decoder 214 determines whether or not the second identification information (priority_id) that is included in the dependent stream indicates the two-dimensional image transmission mode, that is, if “priority_id=0×3E.”

When the second identification information indicates the two-dimensional image transmission mode, in Step ST5, the video decoder 214 determines that the items of image data that are included in the base stream and the dependent stream are the items of data that are the same. Then, in Step ST6, the video decoder 214 decodes only the base stream with the slice decoding unit 214b and thus obtains the two-dimensional image data. Thereafter, in Step ST7, the video decoder 214 ends the processing.

Furthermore, when in Step ST4, the second identification information indicates the stereoscopic image transmission mode, in Step ST8, the video decoder 214 determines that the items of image data that are included in the base stream and the dependent stream are different items of image data. Then, in Step ST9, the video decoder 214 decodes both the base stream and the dependent stream with the slice decoding unit 214b and thus obtains the items of image data on the left eye view and the right eye view. Thereafter, in Step ST7, the video decoder 214 ends the processing.

Furthermore, when in Step ST2, the first identification information (multiview viewposition SEI) is not present in the base stream, in Step ST10, the video decoder 214 sets the dependent stream to be not in service and proceeds to Step ST6. Then, the video decoder 214 decodes only the base stream with the slice decoding unit 214b and thus obtains the two-dimensional image data. Thereafter, in Step ST7, the video decoder 214 ends the processing.

Furthermore, referring back to FIG. 22, the audio decoder 215 furthermore performs the decoding processing on the audio elementary stream that is extracted in the demultiplexer 213 and thus obtains the decoded voice data.

The HDMI transmission unit 216 transmits the image data obtained in the video decoder 214 and the voice data obtained in the audio decoder 215 to an HDMI sink apparatus, the television receiver 300 according to the embodiment, through the HDMI terminal 217 using communication based on HDMI.

As described above, the stereoscopic image data (the items of image data on the left eye view and the right eye view that make up the stereoscopic image) is obtained by the video decoder 214 in the stereoscopic (3D) image transmission mode. The two-dimensional image data is obtained by the video decoder 214 in the two-dimensional (2D) image transmission mode. The HDMI transmission unit 216 transmits the stereoscopic image data in the stereoscopic image transfer format, for example, in “3D Frame Packing,” and also transmits the two-dimensional image data in the same transfer format.

When transmitting the two-dimensional image data, as described below, the HDMI transmission unit 216 obtains the first image data and the second image data that have to be inserted into the insertion portions of the items of image data on the left eye view and the right eye view, respectively. As described above, if “(1) Reformatting of the Two-Dimensional Image Data” is applied, the first image data and the second image data are obtained from the two-dimensional image data according to a stereoscopic (3D) display method for use in the television receiver 300, as follows.

That is, when the stereoscopic display method is the polarization method, the two-dimensional image data is divided into the even line group and the odd line group (refer to FIGS. 7(b) and 7(c)). Then, the processing, such as the line double-writing, is performed on the image data in the even lines, and thus the number of lines is made to be in accordance with the original two-dimensional image data. As a result, the first image data (the left view frame) that is inserted into the portion of the image data on the left eye view is obtained (refer to FIG. 7(d)). Furthermore, the processing, such as the line double-writing, is performed on the image data in the odd lines, and thus the number of lines is made to be in accordance with the original two-dimensional image data. As a result, the second image data (the right view frame) that is inserted into the portion of the image data on the right eye view is obtained (refer to FIG. 7(e)).

Furthermore, when the stereoscopic display method is a shutter method, interpolation frames T_{—}0n, T_{—}1n, and so forth between each frame are generated from frames T_{—}0, T_{—}1, T_{—}2, and so forth of the two-dimensional image data (refer to FIG. 9(a)). Then, each frame of the two-dimensional image data is set to be each frame of the first image data (the left view frame) (refer to FIG. 9(b)). Furthermore, each interpolation frame is set to be each frame of the second image data (the view frame) (refer to FIG. 9(b)).

Furthermore, as described above, if “(2) Transmission of the Identification Information Indicating the Presence of the Two-Dimensional Image Data” is applied, the two-dimensional image data is set to be the first image data that has to be inserted into the insertion portion of the left eye view. Furthermore, a copy of the two-dimensional image data is generated and the copy is set to be the second image data that has to be inserted into the insertion portion of the right eye view.

In this case, the HDMI transmission unit 216 transmits the identification information (2Dflg) indicating whether or not the first image data and the second image data are the items of two-dimensional image data that are the same, with an HDMI interface to the television receiver 300. According to the embodiment, the identification information is inserted during a blanking interval for the image data and thus is transmitted. The HDMI transmission unit 216 is described in detail below.

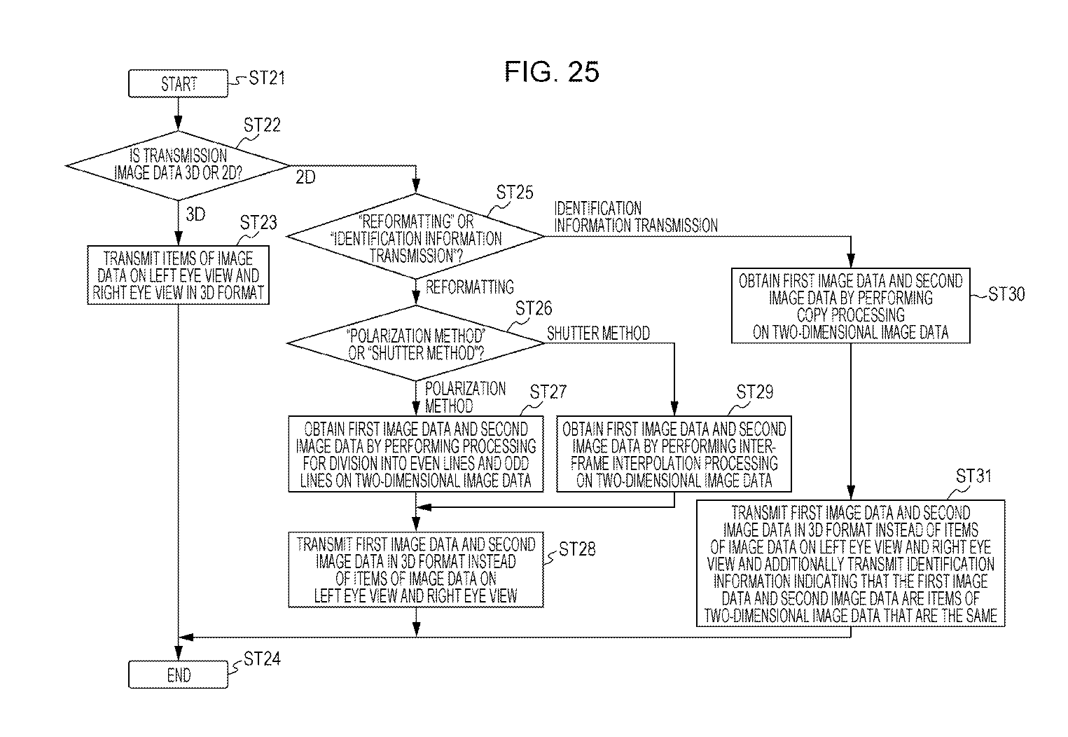

A flow chart in FIG. 25 illustrates one example of transmission processing in the HDMI transmission unit 216 described above. The HDMI transmission unit 216 executes the transmission processing illustrated in the flow chart, for example, every frame.

The HDMI transmission unit 216 starts the processing in Step ST21 and thereafter proceeds to processing in Step ST22. In Step ST22, the HDMI transmission unit 216 determines whether transmission image data is stereoscopic (3D) image data or two-dimensional (2D) image data.

When the transmission image data is the stereoscopic (3D) image data, in Step ST23, the HDMI transmission unit 216 transmits the items of image data on the left eye view and the right eye view that make up the stereoscopic image, in the transfer format of “3D Frame Packing.” Thereafter, in Step ST24, the HDMI transmission unit 216 ends the processing.

In Step ST22, when the transmission image data is the two-dimensional (2D) image data, the HDMI transmission unit 216 proceeds to processing in Step ST25. In Step ST25, the HDMI transmission unit 216 determines which one of “(1) Reformatting of the Two-Dimensional Image Data” and “(2) Transmission of the Identification Information Indicating the Presence of the Two-Dimensional Image Data” is applied. For example, the HDMI transmission unit 216 determines whether the television receiver 300 can correspond to the identification information, using the information that is obtained from an EDID register of the television receiver 300, and based on the result of the determination, determines which one is applied.

When “reformatting” is applied, in Step ST26, the HDMI transmission unit 216 determines whether the stereoscopic display method for use in the television receiver 300 is the “polarization method” or “the shutter method.” When the stereoscopic display method is the “polarization method,” the HDMI transmission unit 216 proceeds to processing in Step ST27.

In Step ST27, the HDMI transmission unit 216 performs processing for division into even and odd lines on the two-dimensional image data and thus generates the first image data and the second image data (refer to FIG. 7). Then, in Step ST28, the HDMI transmission unit 216 transmits the two-dimensional image data in the transfer format of “3D Frame Packing,” by inserting the first image data and the second image data instead of the items of image data on the left eye view and the right eye view. Thereafter, in Step ST24, the HDMI transmission unit 216 ends the processing.

Furthermore, when the stereoscopic display method is the “shutter method” in Step ST26, the HDMI transmission unit 216 proceeds to processing in Step ST29. In Step ST29, the HDMI transmission unit 216 performs the inter-frame interpolation processing on the two-dimensional image data, and thus generates the first image data and the second image data (refer to FIG. 9). Then, in Step ST28, the HDMI transmission unit 216 transmits the two-dimensional image data in the transfer format of “3D Frame Packing,” by inserting the first image data and the second image data instead of the items of image data on the left eye view and the right eye view. Thereafter, in Step ST24, the HDMI transmission unit 216 ends the processing.

Furthermore, in Step ST25, when “identification information transmission” is applied, the HDMI transmission unit 216 proceeds to processing in Step ST30. In Step ST30, the HDMI transmission unit 216 performs copy processing on the two-dimensional image data and thus obtains the first image data and the second image data that are the items of two-dimensional image data that are the same.

Then, in Step ST31, the HDMI transmission unit 216 transmits the two-dimensional image data in the transfer format of “3D Frame Packing,” by inserting the first image data and the second image data instead of the items of image data on the left eye view and the right eye view. Furthermore, in Step ST31, the HDMI transmission unit 216 additionally transmits the identification information (2Dflg) indicating that the first image data and the second image data are the items of image data that are the same. Thereafter, in Step ST24, the HDMI transmission unit 216 ends the processing.

Moreover, the HDMI transmission unit 216 additionally transmits the message information (3Dglassoff) suggesting that the user of the television receiver 300 should perform a specific viewing action, with the HDMI interface to the television receiver 300, according to which one of the stereoscopic image data (the items of image data on the left eye view and the right eye view that make up the stereoscopic image) and the two-dimensional image is transmitted. According to the embodiment, the message information is inserted during the blanking interval for the image data and thus is transmitted.

Operation of the set-top box 200 illustrated in FIG. 22 is described. The television broadcasting signal that is input into the antenna terminal 210 is supplied to the digital tuner 211. In the digital tuner 211, the television broadcasting signal is processed, and thus a predetermined transport stream TS that corresponds to the channel selected by the user is output. The transport stream TS is temporarily accumulated in the TS buffer 212. The video elementary stream and the audio elementary stream are included in the transport stream TS.

In the stereoscopic (3D) image transmission mode, the base stream and the dependent stream that include the items of image data on the left eye view and the right eye view, respectively, that make up the stereoscopic image are included in the transport stream TS. Furthermore, in the two-dimensional image transmission mode, only the base stream including the two-dimensional image data is included. Alternatively, the base stream and the dependent stream that include the items of two-dimensional image data, respectively, are included.

In the demultiplexer 213, each stream (the elementary stream) of the video and the audio is extracted from the transport stream TS that is temporarily accumulated in the TS buffer 212. The video elementary stream is supplied to the video decoder 214, and the audio elementary stream is supplied to the audio decoder 215.

Furthermore, in the demultiplexer 213, 3D_event_descriptor is extracted from the transport stream TS and is transmitted to the CPU 201. In the CPU 201, which one of the stereoscopic image transmission mode and the two-dimensional image transmission mode is present can be grasped from the descriptor. Furthermore, in the CPU 201, the message information suggesting that the user should perform a specific viewing action is obtained from the descriptor.

In the video decoder 214, the decoding processing is performed on the video elementary stream that is extracted in the demultiplexer 213 and thus the image data is obtained. In this case, in the video decoder 214, the processing is performed based on the first identification information that is inserted into the base stream and the second identification information that is inserted into the dependent stream. That is, if the first identification information is not included in the base stream, only the base stream is decoded, and the two-dimensional image data is obtained.

Furthermore, if the first identification information is included in the base stream and the second identification information that is included in the dependent stream indicates the stereoscopic image transmission mode, both the base stream and the dependent stream are decoded, and the stereoscopic image data, that is, the items of image data on the left eye view and the right eye view that make up the stereoscopic image are obtained. Moreover, if the first identification information is included in the base stream and the second identification information that is included in the dependent stream indicates the two-dimensional image transmission mode, only the base stream is decoded, and the two-dimensional image data is obtained.

Furthermore, the audio stream that is extracted in the demultiplexer 213 is supplied to the audio decoder 215. In the audio decoder 215, the decoding processing is performed on the audio stream, and thus the decoded voice data is obtained. The image data that is obtained in the video decoder 214 and the voice data that is obtained in the audio decoder 215 are supplied to the HDMI transmission unit 216.

In the HDMI transmission unit 216, the image data that is obtained in the video decoder 214 and the voice data that is obtained in the audio decoder 215 are transmitted to the television receiver 300 through the HDMI terminal 217 using the communication based on HDMI. In this case, the stereoscopic image data (the items of image data on the left eye view and the right eye view that make up the stereoscopic image) is transmitted, in the stereoscopic image transfer format, for example, in “3D Frame Packing,” from the video decoder 214, and the two-dimensional image data is also transmitted in the same transfer format. Because of this, when transmitting the two-dimensional image data, the first image data and the second image data that have to be inserted into the insertion portions of the items of image data on the left eye view and the right eye view, respectively, are generated.

Furthermore, if the items of two-dimensional image data that are the same, as the first image data and the second image data are transmitted, in the HDMI transmission unit 216, the identification information (2Dflg) indicating that the first image data and the second image data are the items of two-dimensional image data that are the same is transmitted through an HDMI interface to the television receiver 300. Moreover, in the HDMI transmission unit 216, the message information (3Dglassoff) suggesting that the user of the television receiver 300 should perform a specific viewing action is transmitted with the HDMI interface to the television receiver 300, according to which one of the stereoscopic image data (the items of image data on the left eye view and the right eye view that make up the stereoscopic image) and the two-dimensional image is transmitted.

[Configuration Example of the Television Receiver 300]

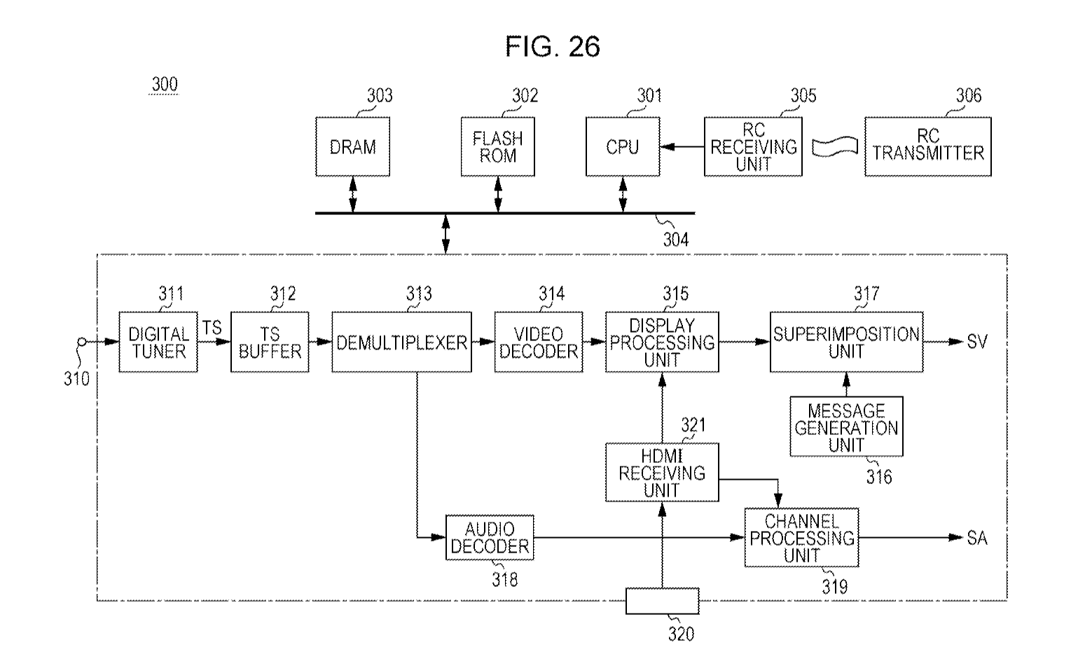

FIG. 26 illustrates a configuration example of the television receiver 300. The television receiver 300 has a CPU 301, a flash ROM 302, a DRAM 303, an internal bus 304, a remote control receiving unit (RC receiving unit) 305, and a remote control transmitter (RC transmitter) 306.

Furthermore, the television receiver 300 has an antenna terminal 310, a digital tuner 311, a transport stream buffer (TS buffer) 312, a demultiplexer 313, a video decoder 314, and a display processing unit 315. Furthermore, the television receiver 300 has a message generation unit 316, a superimposition unit 317, an audio decoder 318, a channel processing unit 319, an HDMI terminal 320, and an HDMI receiving unit 321.

The CPU 301 controls operation of each unit of the television receiver 300. The flash ROM 302 performs storing of control software and keeping of data. The DRAM 303 makes up a work area of the CPU 301. The CPU 301 deploys software and data that are read from the flash ROM 302, on the DRAM 303 and thus activates the software and controls each unit of the television receiver 300. The RC receiving unit 305 receives a remote control signal (a remote control code) that is transmitted from the RC transmitter 306 and supplies the received remote control signal to the CPU 301. The CPU 301 controls each unit of the television receiver 300, based on the remote control code. The CPU 301, the flash ROM 302, and the DRAM 303 are connected to one another with the internal bus 304.

The antenna terminal 310 is a terminal into which a television broadcasting signal received in a receiving antenna (not illustrated) is input. The digital tuner 311 processes the television broadcasting signal that is input into the antenna terminal 310 and thus outputs a predetermined transport stream TS that corresponds to a channel selected by the user. The TS buffer 312 temporarily accumulates the transport stream TS that is output from the digital tuner 311. The video elementary stream and the audio elementary stream are included in the transport stream TS.

In the stereoscopic (3D) image transmission mode, the base stream and the dependent stream that include the items of image data on the left eye view and the right eye view, respectively, that make up the stereoscopic image are included in the transport stream TS. Furthermore, in the two-dimensional image transmission mode, only the base stream including the two-dimensional image data is included. Alternatively, the base stream and the dependent stream that include the items of two-dimensional image data that are the same, respectively, are included.

The demultiplexer 313 extracts each stream (the elementary stream) of video and audio from the transport stream TS that is temporarily accumulated in the TS buffer 312. Furthermore, the demultiplexer 313 extracts 3D_event_descriptor (refer to FIG. 17) described above from the transport stream TS and transmits the extracted 3D_event_descriptor to the CPU 301.

From the 3D event descriptor, the CPU 301 can grasp which one of the stereoscopic image transmission mode and the two-dimensional image transmission mode is present. Furthermore, from the 3D event descriptor, the CPU 301 can obtain the message information suggesting that the user should perform a specific viewing action. Based on the message information, the CPU 301 can control message display data (bitmap data) that is generated from the message generation unit 316.

The video decoder 314 is configured in the same manner as the video decoder 214 in the set-top box 200 described above. The video decoder 314 performs the decoding processing on the video elementary stream that is extracted in the demultiplexer 313 and thus obtains the image data. That is, in the stereoscopic (3D) image transmission mode, the video decoder 314 obtains the items of image data on the left eye view and the right eye view that make up the stereoscopic image. Furthermore, in the two-dimensional (2D) image transmission mode, the video decoder 314 obtains the two-dimensional image data.

At this point, the video decoder 314 performs the decoding processing, based on the first identification information that is inserted into the base stream and the second identification information that is inserted into the dependent stream. As described above, the first identification information is the 3D signaling indicating the presence of the dependent stream other than the base stream. As described above, the second identification information is the 2D/3D signaling indicating which one of the stereoscopic image transmission mode and the two-dimensional image transmission mode is present.

The audio decoder 318 performs the decoding processing on the audio elementary stream that is extracted in the demultiplexer 313, and thus obtains the decoded voice data.

The HDMI receiving unit 321 receives the image data and the voice data through the HDMI terminal 320 from an HDMI source apparatus, the set-top box 200 according to the embodiment, using the communication based on HDMI. At this point, the HDMI receiving unit 321 receives the stereoscopic image data (the items of image data on the left eye view and the right eye view that make up the stereoscopic image) or the two-dimensional image data in a unit of an event.

At this point, the HDMI receiving unit 321 receives the stereoscopic image data in the stereoscopic image transfer format, for example, in “3D Frame Packing,” and also receives the two-dimensional image data in the same transfer format. When receiving the stereoscopic image data, the HDMI receiving unit 321 obtains the items of image data on the left eye view and the right eye view that make up the stereoscopic image. Furthermore, when receiving the two-dimensional image data, the HDMI receiving unit 321 obtains the first image data and the second image data that are inserted into the insertion portions of the items of image data on the left eye view and the right eye view, respectively.

As described above, if “(1) Reformatting of the Two-Dimensional Image Data” is applied in the set-top box 200, the first image data and the second image data are obtained with the reformatting.

For example, when the stereoscopic display method for use in the television receiver 300 is the “polarization method,” the first image data and the second image data are obtained by performing the processing for division into even and odd lines on the two-dimensional image data (refer to FIG. 7). Furthermore, for example, when the stereoscopic display method for use in the television receiver 300 is the “shutter method,” the first image data and the second image data are obtained by performing the inter-frame interpolation processing on the two-dimensional image data (refer to FIG. 9).

Furthermore, as described above, if “(2) Transmission of the Identification Information Indicating the Presence of the Two-Dimensional Image Data” is applied in the set-top box 200, the first image data and the second image data become the items of two-dimensional image data that are the same.

Furthermore, the HDMI receiving unit 321 receives the identification information (2Dflg) indicating whether or not the first image data and the second image data are the items of two-dimensional image data that are the same, with the HDMI interface from the set-top box 200. Moreover, the HDMI receiving unit 321 receives the message information (3Dglassoff) suggesting that the user should perform a specific viewing action, with the HDMI interface from the set-top box 200, according to which one of the stereoscopic image data (the items of image data on the left eye view and the right eye view that make up the stereoscopic image) and the two-dimensional image is transmitted.

The HDMI receiving unit 321 transmits the identification information (2Dflg) and the message information (3Dglassoff) to the CPU 301. The CPU 301 grasps whether the first image data and the second image data that are obtained, in the HDMI receiving unit 321, are the items of two-dimensional image data that are the same from the identification information (2Dflg), and thus can control operation of the display processing unit 315. Furthermore, based on the message information (3Dglassoff), the CPU 301 can control the message display data (the bitmap data) that is generated from the message generation unit 316.

At the time of broadcast reception, the channel processing unit 319 obtains the voice data for each channel for realizing, for example, 5.1 ch surround and the like from the voice data that is obtained in the audio decoder 318 and supplies the obtained voice data to a speaker. Furthermore, at the time of the HDMI input, the channel processing unit 319 obtains voice data SA for each channel for realizing, for example, 5.1 ch surround and the like from the voice data that is received in the HDMI receiving unit 321, and supplies the obtained voice data SA to a speaker.

At the time of the broadcast reception, the display processing unit 315 performs display processing on the image data that is obtained in the video decoder 314 and thus obtains the display image data. When the two-dimensional image data is obtained in the video decoder 314, the display processing unit 315 performs two-dimensional (2D) display processing and thus obtains the display image data for displaying the two-dimensional image.

Furthermore, when the items of image data on the left eye view and the right eye view that make up the stereoscopic image are obtained in the video decoder 314, the display processing unit 315 performs stereoscopic (3D) display processing and thus obtains the display image data for displaying the stereoscopic image. Moreover, the stereoscopic (3D) display processing is made different by using the stereoscopic display method (the polarization method, the shutter method, and the like) for use in the television receiver 300.

Furthermore, at the time of HDMI input, the display processing unit 315 performs the display processing on the image data that is received in the HDMI receiving unit 321 and thus obtains the display image data. At this point, except for a case where the first image data and the second image data that are the items of the two-dimensional image data that are the same are received in the HDMI receiving unit 321, the display processing unit 315 performs the stereoscopic (3D) display processing and obtains the display image data.

In this case, when the items of image data on the left eye view and the right eye view are received in the HDMI receiving unit 321, the stereoscopic (3D) display processing is performed on these items of image data, and thus the display image data for displaying the stereoscopic image is obtained. Furthermore, when the first image data and the second image data that are reformatted are received in the HDMI receiving unit 321, the stereoscopic (3D) display processing is performed on these items of image data, and thus the display image data for displaying the two-dimensional image that has a full resolution is obtained.

Furthermore, except for the case where the first image data and the second image data that are the items of the two-dimensional image data that are the same are received in the HDMI receiving unit 321, the display processing unit 315 performs the two-dimensional (2D) display processing on one of the items of image data and obtains the display image data for displaying the two-dimensional image that has a full resolution.

At the time of the broadcast reception, the message generation unit 316 generates display data on a message suggesting that the user should perform a specific viewing action, for example, on a message relating to mounting and non-mounting of the 3D glasses, based on message information that is extracted from the 3D event descriptor. Furthermore, at the time of the HDMI input, the message generation unit 316 generates the display data on the message suggesting that the user should perform a specific viewing action, for example, on the message relating to the mounting and the non-mounting of the 3D glasses, based on the message information (3Dglassoff) that is transmitted, with the HDMI interface, from the set-top box 200.

The superimposition unit 317 superimposes the message display data (the bitmap data) generated in the message generation unit 316 onto the display image data obtained in the display processing unit 315, obtains final display image data SV, and thus supplies the obtained final display image data SV to a display.

Moreover, it is considered that if the stereoscopic display method for use in the television receiver 300 is the “shutter method,” operation of shutter glasses is controlled based on the message information. For example, when the message information indicates a message indicating the non-mounting of the 3D glasses, the CPU 301 performs control in such a manner that shutter glasses synchronization is turned off, and thus a shutter is opened. Furthermore, for example, when the message information indicates a message indicating the mounting of the 3D glasses, the CPU 301 performs the control in such a manner that the shutter glasses synchronization is turned on, and thus shutter operation is performed.

Operation of the television receiver 300 illustrated in FIG. 26 is described. First, the operation at the time of the broadcast reception is described. The television broadcasting signal that is input into the antenna terminal 310 is supplied to the digital tuner 311. In the digital tuner 311, the television broadcasting signal is processed, and thus a predetermined transport stream TS that corresponds to the channel selected by the user is output. The transport stream TS is temporarily accumulated in the TS buffer 312. The video elementary stream and the audio elementary stream are included in the transport stream TS.

In the stereoscopic (3D) image transmission mode, the base stream and the dependent stream that include the items of image data on the base view and the non-base view, respectively, that make up the stereoscopic image are included in the transport stream TS. Furthermore, in the two-dimensional image transmission mode, only the base stream including the two-dimensional image data is included. Alternatively, the base stream and the dependent stream that include the items of two-dimensional image data, respectively, are included.

In the demultiplexer 313, each stream (the elementary stream) of the video and the audio is extracted from the transport stream TS that is temporarily accumulated in the TS buffer 312. The video elementary stream is supplied to a decode display•processing unit 314, and the audio elementary stream is supplied to the audio decoder 318.

Furthermore, in the demultiplexer 313, 3D_event_descriptor is extracted from the transport stream TS and is transmitted to the CPU 301. In the CPU 301, which one of the stereoscopic image transmission mode and the two-dimensional image transmission mode is present is grasped from the descriptor. Furthermore, in the CPU 301, the message information suggesting that the user should perform a specific viewing action is obtained from the descriptor. In the CPU 301, control of the message generation unit 316 is performed based on the message information, and the message display data (bitmap data) that corresponds to the message information is generated.

In the video decoder 314, the decoding processing is performed on the video elementary stream that is extracted in the demultiplexer 313, and thus the image data is obtained. In this case, in the video decoder 314, the processing is performed based on the first identification information that is inserted into the base stream and the second identification information that is inserted into the dependent stream. That is, if the first identification information is not included in the base stream, only the base stream is decoded, and thus the two-dimensional image data is obtained.

Furthermore, if the first identification information is included in the base stream and the second identification information that is included in the dependent stream indicates the stereoscopic image transmission mode, both the base stream and the dependent stream are decoded, and the items of image data on the left eye view and the right eye view that make up the stereoscopic image are obtained. Moreover, if the first identification information is included in the base stream and the second identification information that is included in the dependent stream indicates the two-dimensional image transmission mode, only the base stream is decoded, and the two-dimensional image data is obtained.

The image data that is obtained by the video decoder 314 is supplied to the display processing unit 315. In the display processing unit 315, the display processing is performed on the image data that is obtained in the video decoder 314, and the display image data is obtained. That is, when the two-dimensional image data is obtained in the video decoder 314, in the display processing unit 315, the two-dimensional (2D) display processing is performed, and thus the display image data for displaying the two-dimensional image is obtained.

Furthermore, when the items of image data on the left eye view and the right eye view that make up the stereoscopic image are obtained in the video decoder 314, in the display processing unit 315, the stereoscopic (3D) display processing is performed, and thus the display image data for displaying the stereoscopic image is obtained. Moreover, the stereoscopic (3D) display processing is set to be different, using the stereoscopic display method (the polarization method, the shutter method, and the like) for use in the television receiver 300.

The display image data that is obtained in the display processing unit 315 is supplied to the superimposition unit 317, and thus the message display data from the message generation unit 316 is superimposed and the final display image data SV is obtained. The display image data SV is supplied to the display, and the stereoscopic image displaying or the two-dimensional image displaying on the display is performed.

Now, in a case of the two-dimensional image displaying, the message suggesting the non-mounting of the 3D glasses is displayed on the image in a manner that is superimposed onto the image, and in a case of the stereoscopic image displaying, the message suggesting the mounting of the 3D glasses is superimposed onto the image. Accordingly, it is possible for the user to view the image in a correct viewing state.

Furthermore, now, if the stereoscopic display method is the “shutter method,” the operation of the shutter glasses is controlled by the CPU 301, based on the message information. For example, in the case of the two-dimensional image displaying, the shutter glasses synchronization is turned off, and thus the shutter is opened. Because of this, the user, although wearing the shutter glasses, can view the two-dimensional image with a full resolution in a time direction. Furthermore, for example, in the case of the stereoscopic image displaying, the shutter glasses synchronization is turned on, and the shutter operation is performed. Because of this, the user can satisfactorily view the stereoscopic image.

Next, the operation at the time of the HDMI input is described. The image data and the voice data are received by the HDMI receiving unit 321 using the communication based on HDMI. In this case, in the HDMI receiving unit 321, the stereoscopic image data is received in the stereoscopic image transfer format, for example, in “3D Frame Packing,” and the two-dimensional image data is also received in the same transfer format.

When receiving the stereoscopic image data, in the HDMI receiving unit 321, the items of image data on the left eye view and the right eye view that make up the stereoscopic image are obtained. Furthermore, when receiving the two-dimensional image data, in the HDMI receiving unit 321, the first image data and the second image data that are inserted into the insertion portions of the items of image data on the left eye view and the right eye view, respectively, are obtained.

For example, if the “reformatting” is applied in the set-top box 200 and the stereoscopic display method for use in the television receiver 300 is the “polarization method,” the first image data and the second image data are obtained by performing the processing for division into even and odd lines on the two-dimensional image data (refer to FIG. 7). Furthermore, for example, if the “reformatting” is applied in the set-top box 200 and the stereoscopic display method for use in the television receiver 300 is the “shutter method,” the first image data and the second image data are obtained by performing the inter-frame interpolation processing on the two-dimensional image data (refer to FIG. 9). Moreover, if the “identification information transmission” is applied in the set-top box 200, the first image data and the second image data become the items of two-dimensional image data that are the same.

Furthermore, in the HDMI receiving unit 321, the identification information (2Dflg) indicating whether or not the first image data and the second image data are the items of two-dimensional image data that are the same, and the message information (3Dglassoff) suggesting that the user should perform a specific viewing action are received, with the HDMI interface, from the set-top box 200. These items of information are transmitted to the CPU 301.

In the CPU 301, it is grasped whether the first image data and the second image data that are obtained, with the HDMI receiving unit 321, from the identification information (2Dflg) are the items of two-dimensional image data that are the same, and the control operation of the display processing unit 315 is performed. Furthermore, in the CPU 301, the control of the message generation unit 316 is performed based on the message information (3Dglassoff), and the message display data (bitmap data) that corresponds to the message information (3Dglassoff) is generated.

The image data that is received in the HDMI receiving unit 321 is supplied to the display processing unit 315. In the display processing unit 315, the display processing is performed on the image data that is received in the HDMI receiving unit 321, and the display image data is obtained. That is, except for the case where the first image data and the second image data that are the items of two-dimensional image that are the same are received in the HDMI receiving unit 321, in the display processing unit 315, the stereoscopic (3D) display processing is performed and thus the display image data is obtained. Moreover, the stereoscopic (3D) display processing is set to be different, using the stereoscopic display method (the polarization method, the shutter method, and the like) for use in the television receiver 300.

In this case, when the items of image data on the left eye view and the right eye view are received in the HDMI receiving unit 321, the stereoscopic (3D) display processing is performed on these items of image data, and thus the display image data for displaying the stereoscopic image is obtained (refer to FIG. 5). Furthermore, when the first image data and the second image data that are reformatted in the HDMI receiving unit 321 are received, the stereoscopic (3D) display processing is performed on these items of image data, and thus the display image data for displaying the two-dimensional image that has a full resolution is obtained (refer to FIGS. 8 and 10).

Furthermore, in the case where the first image data and the second image data that are the items of the two-dimensional image data that are the same are received in the HDMI receiving unit 321, in the display processing unit 315, the two-dimensional (2D) display processing is performed on one of the items of image data and thus the display image data for displaying the two-dimensional image that has a full resolution is obtained (refer to FIG. 11).

The display image data that is obtained in the display processing unit 315 is supplied to the superimposition unit 317, and thus the message display data from the message generation unit 316 is superimposed and the final display image data SV is obtained. The display image data SV is supplied to the display, and the stereoscopic image displaying or the two-dimensional image displaying on the display is performed.

Now, in a case of the two-dimensional image displaying, the message suggesting the non-mounting of the 3D glasses is superimposed onto the image, and in a case of the stereoscopic image displaying, the message suggesting the mounting of the 3D glasses is displayed on the image in a manner that is superimposed onto the image. Accordingly, it is possible for the user to view the image in a correct viewing state.

Furthermore, now, if the stereoscopic display method is the “shutter method,” the operation of the shutter glasses is controlled by the CPU 301, based on the message information. For example, in the case of the two-dimensional image displaying, the shutter glasses synchronization is turned off, and thus the shutter is opened. Because of this, the user, although wearing the shutter glasses, can view the two-dimensional image with a full resolution in a time direction. Furthermore, for example, in the case of the stereoscopic image displaying, the shutter glasses synchronization is turned on, and the shutter operation is performed. Because of this, the user can satisfactorily view the stereoscopic image.

Furthermore, the voice data that is received in the HDMI receiving unit 321 is supplied to the channel processing unit 319. In the channel processing unit 319, the voice data SA on each channel for realizing 5.1 ch surround and the like is generated with respect to the voice data. The voice data SA is supplied to the speaker, and voice output that is made to be in accordance with the image displaying is made available.

[Configuration Examples of HDMI Transmission Unit and HDMI Receiving Unit]

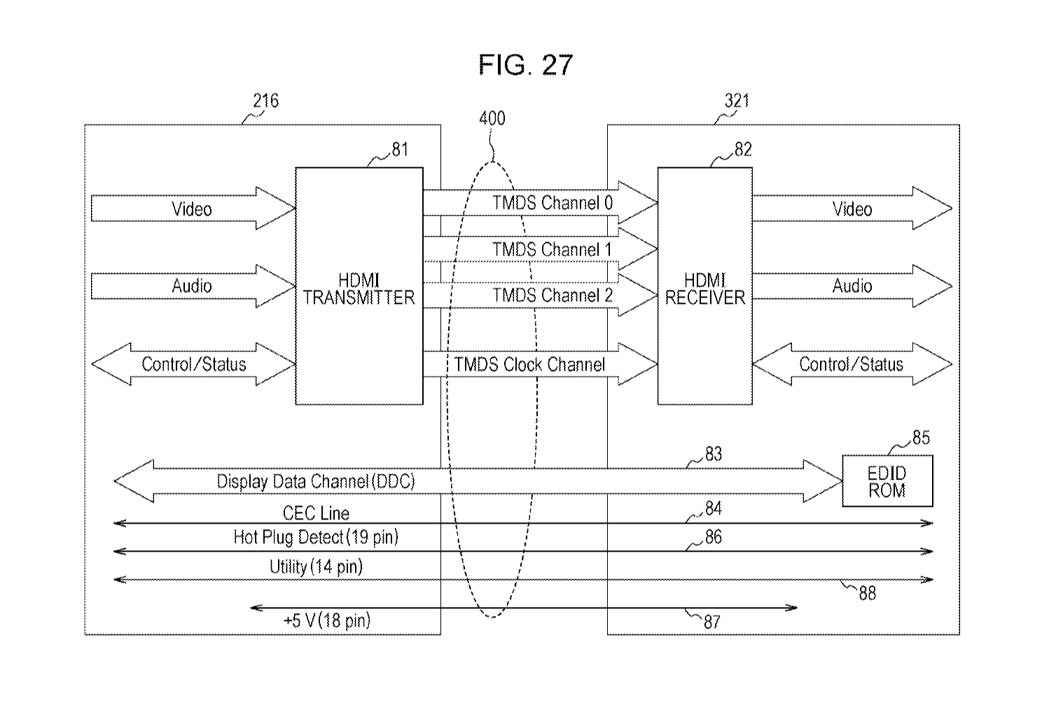

FIG. 27 illustrates configuration examples of the HDMI transmission unit 216 of the set-top box 200 and of the HDMI receiving unit 321 of the television receiver 300 in the image transmission and receiving system 10 in FIG. 1.

In an effective image interval (hereinafter suitably referred to as an active video interval), the HDMI transmission unit 216 transmits a differential signal that corresponds to the pixel data on the image for one non-compressed screen, to the HDMI receiving unit 321 in one direction over multiple channels. At this point, the effective image interval is an interval that results from removing a horizontal blanking interval and a vertical blanking interval from an interval from one vertical synchronization signal to the next vertical synchronization signal. Furthermore, in the horizontal blanking interval or the vertical blanking interval, the HDMI transmission unit 216 transmits the differential signal that corresponds to the voice data or control data accompanying at least the image, other items of auxiliary data, or the like, to the HDMI receiving unit 321 in one direction over multiple channels.

As transfer channels for an HDMI system that is made from the HDMI transmission unit 216 and the HDMI receiving unit 321, there are transfer channels described below. That is, there are three TMDS channels #0 to #2 as the transfer channels for synchronizing the pixel data and the voice data with a pixel clock and thus transferring the synchronized pixel data and voice data in one direction from the HDMI transmission unit 216 to the HDMI receiving unit 321. Furthermore, there is a TMDS clock channel as the transfer channel for transferring the pixel clock.

The HDMI transmission unit 216 has an HDMI transmitter 81. The transmitter 81 converts, for example, the pixel data on the non-compressed image into the corresponding differential signal and serial-transfers, in one direction, the result of the conversion to the HDMI receiving unit 321 that is connected through the HDMI cable 400 over the multiple channels, the three TMDS channels #0, #1, and #2.

Furthermore, the transmitter 81 converts the voice data accompanying the non-compressed image, the necessary control data, other items of auxiliary data, and the like into the corresponding differential signal and serial-transfers the result of the conversion to the HDMI receiving unit 321 in one direction over the three TMDS channels #0, #1, and #2.

Moreover, the transmitter 81 transmits the pixel clock that is synchronized with the pixel data which is transmitted over the three TMDS channels #0, #1, and #2, to the HDMI receiving unit 321 that is connected through the HDMI cable 400, over the TMDS clock channel. At this point, 10-bit pixel data is transmitted at one clock in terms of the pixel clock over one TMDS channel #i (i=0, 1, 2).

In the active video interval, the HDMI receiving unit 321 receives the differential signal that is transmitted in one direction from the HDMI transmission unit 216, and that corresponds to the pixel data, over the multiple channels. Furthermore, in the horizontal blanking interval or the vertical blanking interval, the HDMI receiving unit 321 receives the differential signal that is transmitted in one direction from the HDMI transmission unit 216, and that corresponds to the voice data or the control data, over the multiple channels.

That is, the HDMI receiving unit 321 has an HDMI receiver 82. The HDMI receiver 82 receives the differential signal that is transmitted in one direction from the HDMI transmission unit 216, and that corresponds to the pixel data, and the differential signal that corresponds to the voice data or the control data, over the TMDS channels #0, #1, and #2. In this case, these differential signals are synchronized with the pixel clock that is transmitted from the HDMI transmission unit 216 over the TMDS clock channel and thus are received.

As the transfer channels for the HDMI system, in addition to the TMDS channels #0 to #2 and the TMDS clock channel that are described above, there are transfer channels that are called a display data channel (DDC) 83 or a CEC line 84. The DDC 83 is made from two signal lines, not illustrated, that are included in the HDMI cable 400. The DDC 83 is used in order for the HDMI transmission unit 216 to read enhanced extended display identification data (E-EDID) from the HDMI receiving unit 321.

That is, in addition to the HDMI receiver 81, the HDMI receiving unit 321 has EDID read only memory (ROD) 85 that stores the E-EDID that is performance information relating to its own performance (configuration/capability). For example, the HDMI transmission unit 216 reads the E-EDID, through DDC 83, from the HDMI receiving unit 321 that is connected through the HDMI cable 400, according to a request from a control unit (a CPU) not illustrated.

The HDMI transmission unit 216 transmits the E-EDID that is read, to the control unit (the CPU). The control unit (the CPU) can recognize setting of performance of the HDMI receiving unit 321, based on the E-EDID. For example, the control unit (the CPU) recognizes whether or not the television receiver 300 having the HDMI receiving unit 321 can handle the stereoscopic image data, and if so, whether or not what TMDS transfer data structure the television receiver 300 can support, and so on.

The CEC line 84 is made from one signal line, not illustrated, that is included in the HDMI cable 400 and is used in order to perform bidirectional control data communication between the HDMI transmission unit 216 and the HDMI receiving unit 321. The CEC line 84 makes up a control data line.

Furthermore, a line (an HPD line) 86 that is connected to a pin called a hot plug detect (HPD) is included in the HDMI cable 400. A source apparatus can detect connection of the sink apparatus by using the corresponding line 86. Moreover, the HPD line 86 is used also as “HEAC−line” that makes up a bidirectional communication path. Furthermore, a line (a power supply line) 87 that is used to supply electrical power from the source apparatus to the sink apparatus is included in the HDMI cable 400. Moreover, a utility line 88 is included in the HDMI cable 400. The utility line 88 is used also as the “HEAC+line” that makes up the bidirectional communication path.

[Transmission and Receiving of the Identification Information (2Dflg) and the Message Information (3Dglassoff) Using HDMI]

A method is described in which the identification information (2Dflg) indicating whether or not the first image data and the second image data are the items of two-dimensional image data that are the same and the message information (3Dglassoff) suggesting that the user should perform a specific viewing action are transmitted and received with the HDMI interface. As such a method, for example, a method is considered in which an information packet, for example, an HDMI Vendor Specific InfoFrame (VS_Info), that is arranged during the blanking interval for the image data is used.

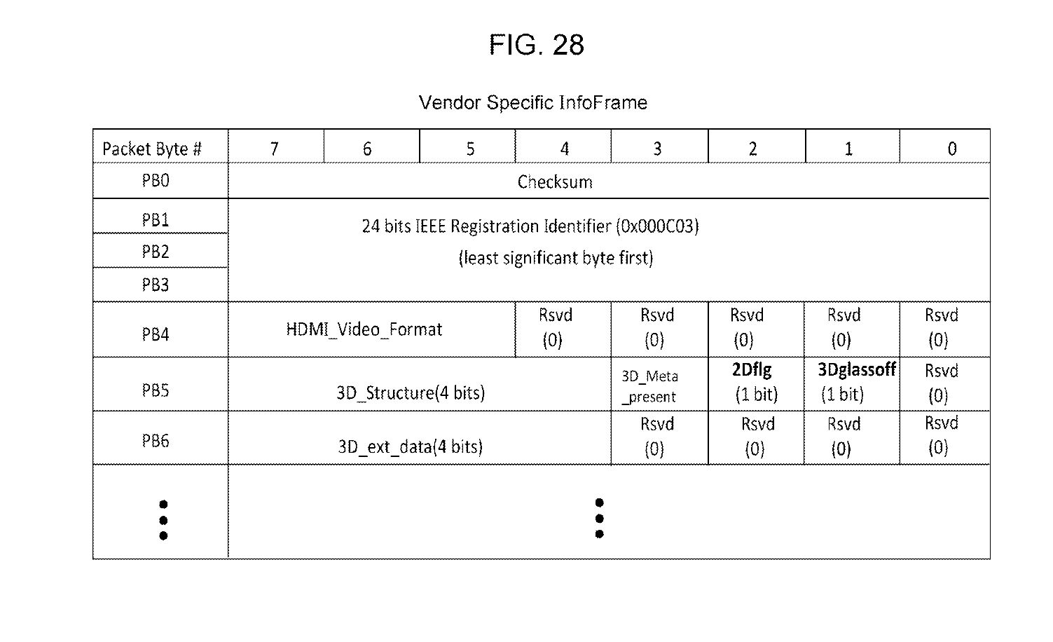

FIG. 28 illustrates a packet syntax of HDMI Vendor Specific InfoFrame. The HDMI Vendor Specific InfoFrame is defined in CEA-861-D and thus a detailed description thereof is omitted.

“HDMI_Video_Format,” 3-bit information indicating a type of image data is arranged in a space from the seventh bit to the fifth bit, in the fourth byte (PB4). According to the embodiment, because 3D data transfer is always made, the 3-bit information is set to be “010.” Furthermore, in a case of the presence of the 3D data transfer, “3D_Structure,” 4-bit information indicating the transfer format is arranged in a space from the seventh bit to the fourth bit in the fifth byte (PB5). For example, in a case of a frame packing method (3D Frame Packing), the 4-bit information is set to be “0000.”

Furthermore, for example, “2Dflg,” 1-bit information is arranged in the second bit in the fifth byte (PB5). The information, as described above, makes up the identification information indicating whether or not the items of image data on the two views that are transmitted in “3D Frame Packing,” that is, the first image data and the second image data are the items of two-dimensional image data that are the same. “1” indicates the two-dimensional image data, “left view=right view.” “0” indicates the stereoscopic image data, “left view≠right view.” Moreover, even though “3D_Structure” is “1000” (side by side) or “0110” (top and bottom), that “left view” and “right view” are the same can be indicated with “2Dflg” in the same manner.

Furthermore, for example, the 1-bit identification information, “3Dglassoff,” is arranged in a space of the first bit in the fifth packet (PB5). The information, as described above, makes up the message information suggesting that the user should perform a specific viewing action. If “3D Structure” indicates the 3D format, the information assigns operation of the 3D glasses to the image that is displayed at the HDMI sink side. “1” requires that the 3D glasses synchronization be turned off and thus the shutter be opened or the 3D glasses be taken off. “0” requires that the 3D glasses synchronization be turned on and thus the shutter be operated or the 3D glasses be worn.

As described above, in the image transmission and receiving system 10 illustrated in FIG. 1, regardless of whether the image data is the stereoscopic (3D) image data or the two-dimensional (2D) image data, the HDMI transfer of the image data from the set-top box 200 to the television receiver 300 is always performed in the stereoscopic image transfer format, for example, in “3D Frame Packing.” Because of this, even though there is switching from the stereoscopic (3D) image data to the two-dimensional (2D) image data, or from the two-dimensional (2D) image data to the stereoscopic (3D) image data, a change in the format parameter of the digital interface does not occur. Because of this, a change in a connection parameter between the apparatuses does not occur and an occurrence of the non-display intervals (the mute intervals) can be suppressed in the television receiver 300.

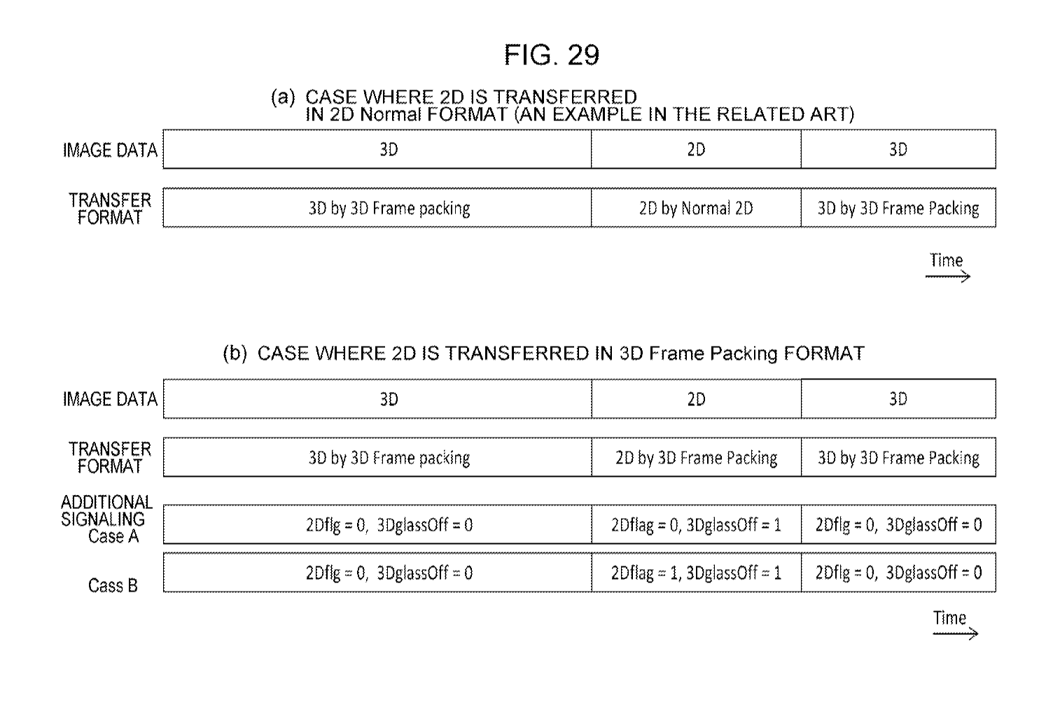

FIG. 29(b) illustrates a case where according to the embodiment, the image data that is transmitted from the set-top box 200 to the television receiver 300 is dynamically changed from the stereoscopic (3D) image data to the two-dimensional (2D) image data, or from the two-dimensional (2D) image data to the stereoscopic (3D) image data. In this case, the transfer format is also set to be “3D Frame Packing.”

In this case, with regard to the signaling added according to the present technology, the expression is set to be “2Dflg=0” and “3Dglassoff=0” when the stereoscopic (3D) image data is transferred. Furthermore, when the two-dimensional (2D) image data is transferred, if the “reformatting” is applied (a case A), the expression is set to be “2Dflg=0,” and “3Dglassoff=1,” and if the “identification information transmission” is applied (a case B), the expression is set to be “2Dflg=1,” and “3Dglassoff=1.”

Moreover, FIG. 29(a) illustrates a case (an example in the related art) in which the two-dimensional (2D) image data is transferred in the transfer format of “2D Normal.” In this case, when the switching is performed from the stereoscopic (3D) image data to the two-dimensional (2D) image data, or from the two-dimensional (2D) image data to the stereoscopic (3D) image data, the change in the format parameter of the digital interface occurs. Because of this, a change in a parameter for setting a connection between the set-top box 200 and the television receiver 300 occurs, and there is a likelihood that the non-display interval (the mute interval) will occur in the television receiver 300.

Furthermore, in the image transmission and receiving system 10 in FIG. 1, if the two-dimensional image data is transferred from the set-top box 200 to the television receiver 300 in the stereoscopic image transfer format, for example, in “3D Frame Packing,” the “reformatting” or the “identification information transmission” is applied.

If the “reformatting” is applied, when the stereoscopic display method for use in the television receiver 300 is the “polarization method,” the first image data and the second image data that have to be inserted into the insertion portions of the left eye view and the right eye view, respectively, are obtained by performing the processing for division into even and odd lines on the two-dimensional image data (refer to FIG. 7). Furthermore, when the stereoscopic display method for use in the television receiver 300 is the “shutter method,” the corresponding first image data and the corresponding second image data are obtained by performing the inter-frame interpolation processing on the two-dimensional image data (refer to FIG. 9).

Because of this, in this case, in the television receiver 300, the stereoscopic display processing is performed on the first image data and the second image data, but it is possible to perform the two-dimensional image displaying that has a full resolution with respect to the display capability (refer to FIGS. 8 and 10).

Furthermore, if the “identification information transmission” is applied, the first image data and the second image data are the items of two-dimensional image data that are the same, but only either of the items of image data is used, and thus two-dimensional display processing is performed in the television receiver 300, based on the identification information (2Dflg). Because of this, also in this case, it is possible to perform the two-dimensional image displaying that has a full resolution with respect to the display capability (refer to FIG. 11).

Furthermore, in the image transmission and receiving system 10 illustrated in FIG. 1, the message information (3Dglassoff) suggesting that the user should take a specific view action, for example, the mounting or the non-mounting of the 3D glasses, is transmitted from the set-top box 200 through the HDMI interface to the television receiver 300. Because of this, the user of the television receiver 300 performs the mounting or the non-mounting of the 3D glasses, based on the message that is displayed on the image in a manner that is superimposed onto the image, and thus it is possible to easily view the image in the correct state.

### 2. Modification Example

Moreover, according to the embodiment described above, the example is illustrated in which the message is displayed on the image in a manner that is superimposed on the image, based on the message information (3Dglassoff) at the television receiver 300 side. However, a descriptor (a component descriptor or an MVC extension descriptor) of the system at the set-top box 200 side may be checked, and when a 3D service is changed to a 2D service, the message giving a notification that the 3D glasses should be taken off may be pasted to the image and thus be transmitted to the television receiver 300. In this case, it is not known that the 2D service is present at the television receiver 300 side, but it is possible to view the 2D image that has a full resolution, without the 3D glasses.

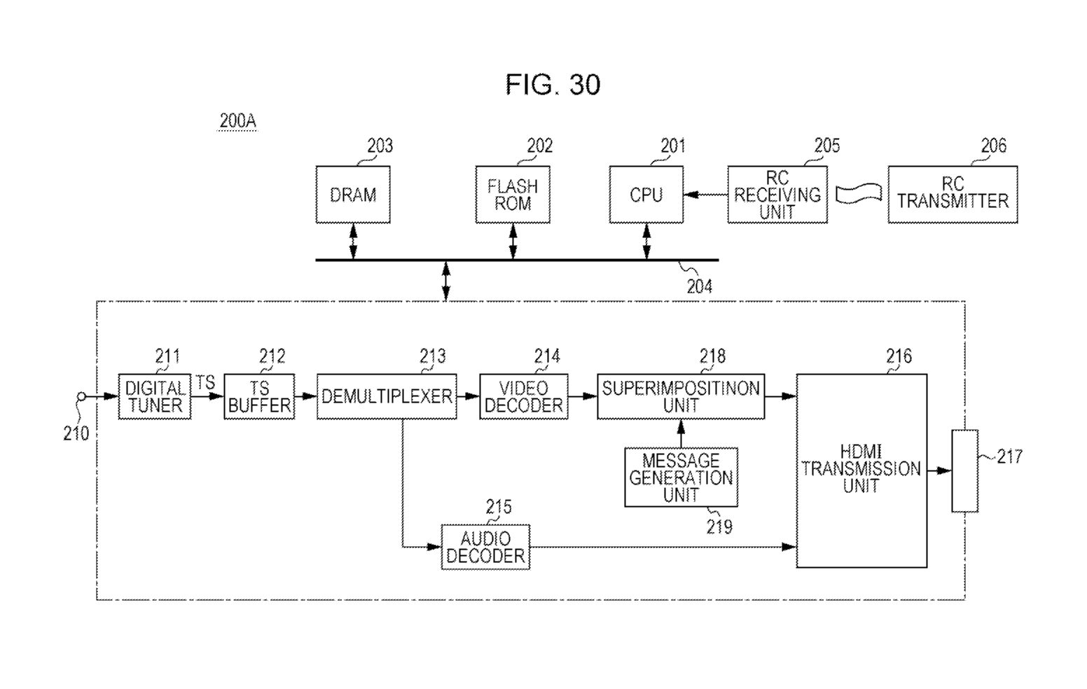

FIG. 30 illustrates a configuration example of a set-top box 200A in such a case. FIG. 30 illustrates components corresponding to those in FIG. 22, which are given like reference numerals, respectively. In the set-top box 200A, a message generation unit 219 that generates a message display signal and a superimposition unit 218 that superimposes the message display signal to the image data are provided.

Furthermore, according to the embodiment described above, the set-top box 200 determines whether or not the dependent stream (an additional stream) other than the base stream is present, based on a multiview_view_position SEI message. Furthermore, the set-top box 200 determines which one of the stereoscopic image transmission mode and the two-dimensional image transmission mode is present, based on “priority_id” of “NAL unit header mvc extension.”

Even though the identification information is not present, the set-top box 200 can perform 2D detection. For example, it is determined that the base stream of received data is 2D without the dependent stream (the additional stream). That is, whether there is 3D or 2D based on whether a received stream is supplied in the form of multiple view streams that make up 3D, or is configured from one view stream that makes up 2D.

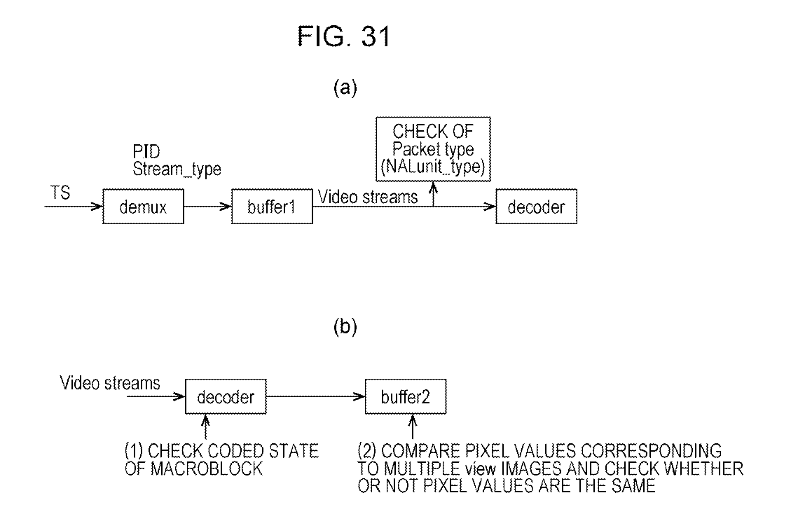

Specifically, as illustrated in FIG. 31(a), a received transport stream packet TS is stored, through the demultiplexer, in a video buffer, the video stream is read from the buffer after a predetermined time elapses, the NAL unit type is checked, and it is determined whether the stream is of one type or multiple types. If the stream is of one type only, it is detected that the stream is 2D.

Furthermore, for example, it is determined that among items of view data of the received data, multiple items of view data that make up a 3D view are configured from the items of data that are the same. Specifically, as illustrated in FIG. 31(b), there are a method (1) of checking whether or not a state of a macroblock at the time of the decoding is of the same data between the multiple view streams and a method (2) of checking whether or not the items of pixel data that result after the decoding are the same in the multiple items of view data.

Furthermore, according to the embodiment described above, the example is illustrated in which the items of image data on the left eye view and the right eye view are handled as the stereoscopic image data. However, the present technology can be applied to a case where the items of image data on the multiple views are handled as the stereoscopic image data.

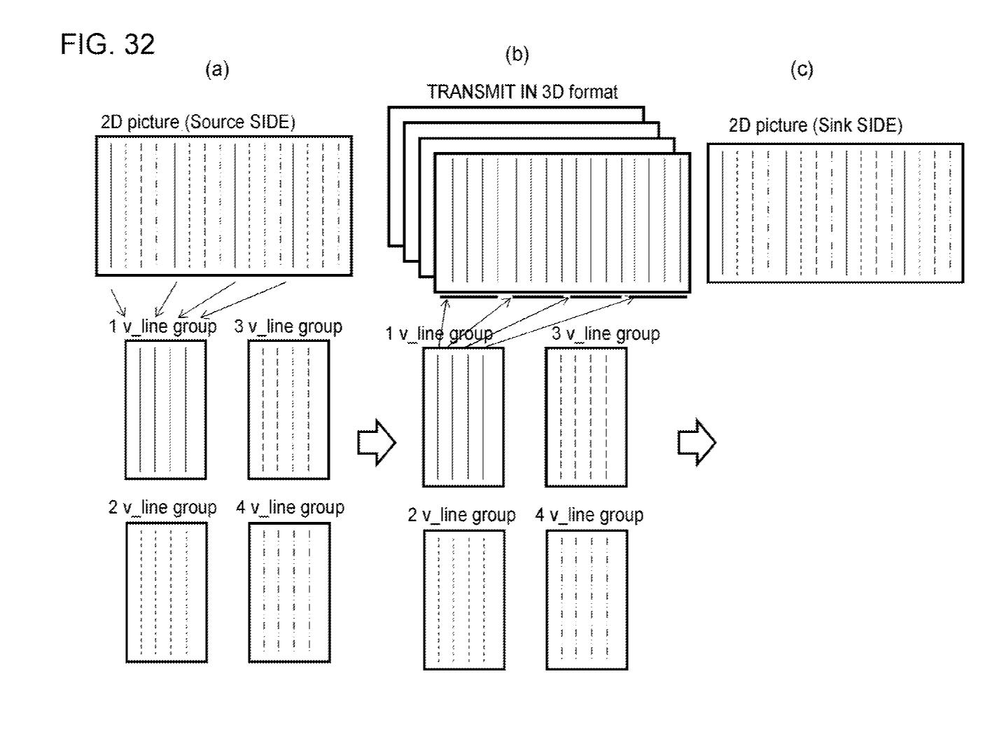

For example, FIG. 32 schematically illustrates a processing example of the reformatting (the polarization method) in a case where the stereoscopic image data is configured from the items of image data on four views. (a) At the source side (at the set-top box 200 side), each line (in this example, each line in the horizontal direction) of the two-dimensional image data is sequentially divided into four groups. (b) Then, the number of lines in each group is made to be in accordance with the number of lines of the original two-dimensional image data, using quadruple writing, and thus first, second, third, and fourth image data are generated. The four items of image data are transferred from the source side to the sink side (the television receiver 300 side) in the stereoscopic image transfer format. (c) At the sink side, the display image data for displaying the two-dimensional image that has a full resolution can be generated by performing stereoscopic image displaying processing on the four items of image data.

Furthermore, according to the embodiment described above, the example is illustrated in which the container is the transport stream (MPEG-2 TS). However, the present technology can be applied also to a system that has a configuration in which distribution to a receiving terminal is made using a network such as the Internet. In a case of the distribution over the Internet, most of the time, the distribution is made with MP4 or other containers in the format other than MP4. That is, as the container, there are containers in various formats, such as a transport stream (MPEG-2TS) that is employed as a digital broadcast specification and MP4 that is used in the distribution over the Internet.

Furthermore, according to the embodiment described above, the connection between the set-top box 200 and the television receiver 300 with the HDMI digital interface is illustrated. However, the present technology can be, of course, applied in the same manner also in a case where the set-top box 200 and the television receiver 300 are connected with the same digital interface (including a wireless interface in addition to a wired interface) as the HDMI digital interface.

Furthermore, according to the embodiment described above, as the method in which the identification information (2Dflg) or the message information (3Dglassoff) is transmitted from the set-top box 200 to the television receiver 300, the method is described in which the HDMI vendor specific infoFrame is used. Besides, a method in which an active space is used, and transmission through a bidirectional communication path configured from an HPD line 86 (HEAC−line) and the utility line 88 (HEAC+line) are considered.

Furthermore, the present technology can be configured as follows.

(1) A transmission apparatus including: an image data obtainment unit that obtains image data; and a transmission unit that transmits the obtained image data to an external apparatus, in which when the image data that is obtained is items of image data on a left eye view and a right eye view that make up a stereoscopic image, the transmission unit transmits the image data on each of the left eye view and the right eye view in a stereoscopic image transfer format, and in which when the image data that is obtained is two-dimensional image data, the transmission unit transmits the two-dimensional image data in the stereoscopic image transfer format.

(2) The transmission apparatus according to (1), in which when transmitting the two-dimensional image data, the transmission unit reformats the two-dimensional image data, and thus generates first image data and second image data that have to be inserted into insertion portions of the items of image data on the left eye view and the right eye view, respectively.

(3) The transmission apparatus according to (2), further including: an information obtainment unit that obtains information for a stereoscopic display method in the external apparatus, in which according to the obtained information for the stereoscopic display method, the transmission unit performs reformatting of the two-dimensional image data and thus obtains the first image data and the second image data.

(4) The transmission apparatus according to (3), in which when the stereoscopic display method is a polarization method, the transmission unit divides the two-dimensional image data into image data in even lines and image data in odd lines, configures the first image data from the image data in even lines, and configures the second image data from the image data in odd lines.

(5) The transmission apparatus according to (3), in which when the stereoscopic display method is a shutter method, the transmission unit configures each frame of the first image data from each frame of the two-dimensional image data and configures each frame of the second image data from an interpolation frame between each frame of the two-dimensional image data.

(6) The transmission apparatus according to (1), in which when transmitting the two-dimensional image data, the transmission unit sets the two-dimensional image data to be first image data and second image data that have to be inserted into insertion portions of the items of image data on the left eye view and the right eye view, respectively, and transmits identification information indicating that the first image data and the second image data are the items of two-dimensional image data that are the same.

(7) The transmission apparatus according to any one of (1) to (6), in which the transmission unit transmits message information suggesting that a user should perform a specific viewing action, which is in accordance with the image data that is transmitted in the stereoscopic image transfer format.

(8) The transmission apparatus according to any one of (1) to (7), further including: a superimposition unit that superimposes display data on a message suggesting that a user should perform a specific viewing action, onto the obtained image data.

(9) A transmission method including: an image data obtainment step of obtaining image data; and a transmission step of transmitting the obtained image data to an external apparatus, in which in the transmission step, when the image data that is obtained is items of image data on a left eye view and a right eye view that make up a stereoscopic image, the image data on each of the left eye view and the right eye view is transmitted in a stereoscopic image transfer format, and in which in the transmission step, when the image data that is obtained is two-dimensional image data, the two-dimensional image data is transmitted in the stereoscopic image transfer format.

(10) A receiver including: a receiving unit that receives first image data and second image data that are transmitted, in a stereoscopic transfer format, from an external apparatus, and that receives identification information indicating whether the first image data and the second image data are items of image data on a left eye view and a right eye view that make up a stereoscopic image or are items of two-dimensional image data that are the same; and a processing unit that obtains display image data by performing processing on the first image data and the second image data that are received, based on the received identification information.

(11) The receiver according to (10), in which when the identification information indicates that the first image data and the second image data are the items of image data on the left eye view and the right eye view that make up the stereoscopic image, the processing unit obtains display image data for displaying the stereoscopic image by processing the first image data and the second image data, and in which when the identification information indicates that the first image data and the second image data are the items of two-dimensional image data that are the same, the processing unit obtains display image data for displaying a two-dimensional image by using one of the first image data and the second image data.

(12) A receiving method including: a receiving step of receiving first image data and second image data that are transmitted, in a stereoscopic transfer format, from an external apparatus and of receiving identification information indicating whether the first image data and the second image data are items of image data on a left eye view and a right eye view that make up a stereoscopic image or are items of two-dimensional image data that are the same; and a processing step of obtaining display image data by performing processing on the first image data and the second image data that are received, based on the received identification information.

(13) A receiver including: a receiving unit that receives image data that is transmitted, in a stereoscopic transfer format, from an external apparatus, and that receives message information indicating a message suggesting that a user should perform a specific action, which is in accordance with whether the image data is image data for displaying stereoscopic image or is image data for displaying a two-dimensional image; a processing unit that obtains display image data for displaying the stereoscopic image or the two-dimensional image by processing the received image data; a message generation unit that obtains message display data, based on the received message information; and a superimposition unit that superimposes the obtained message display data onto the obtained display image data.

(14) The receiver according to (13), further including: a control unit that controls operation of shutter glasses, based on the received message information, in which a stereoscopic display method is a shutter method.

(15) A receiving method including: a receiving step of receiving image data that is transmitted, in a stereoscopic transfer format, from an external apparatus and of receiving message information indicating a message suggesting that a user should perform a specific action, which is in accordance with whether the image data is image data for displaying stereoscopic image or is image data for displaying a two-dimensional image; a processing step of obtaining display image data for displaying the stereoscopic image or the two-dimensional image by processing the received image data; a message generation step of obtaining message display data, based on the received message information; and a superimposition step of superimposing the obtained message display data onto the obtained display image data.

(16) A transmission apparatus including: an image data obtainment unit that obtains image data; and a transmission unit that transmits the image data to an external apparatus, in which when the image data that is obtained is items of image data on multiple views that make up a stereoscopic image, the transmission unit transmits the image data on each of the multiple views in a stereoscopic image transfer format, and in which when the image data that is obtained is two-dimensional image data, the transmission unit transmits the two-dimensional image data in the stereoscopic image transfer format.

Main features of the present technology are that regardless of whether the image data is 3D or 2D, HDMI transfer of the image data from a STB 200 to a TV 300 is always performed in the 3D transfer format and thus the non-display interval (the mute interval) in the TV 300 can be considerably reduced without the change in the format parameter when the switching is performed between 3D and 2D (refer to FIG. 29).

### REFERENCE SIGNS LIST

10 IMAGE TRANSMISSION AND RECEIVING SYSTEM
100 BROADCASTING STATION
110 TRANSMISSION-DATA GENERATION UNIT
111 DATA EXTRACTION UNIT
111a IMAGE CAPTURING MEDIUM
111b VOICE INPUT MEDIUM
111c DATA RECORDING MEDIUM
112 VIDEO ENCODER
113 AUDIO ENCODER
114 MULTIPLEXER
200, 200A SET-TOP BOX
201 CPU
211 DIGITAL TUNER
212 TRANSPORT STREAM BUFFER
213 DEMULTIPLEXER
214 VIDEO DECODER
214a NAL UNIT PARSING UNIT
214b SLICE DECODING UNIT
214c SPS/PPS/SEI PROCESSING UNIT
215 AUDIO DECODER
216 HDMI TRANSMISSION UNIT
217 HDMI TERMINAL
218 SUPERIMPOSITION UNIT
219 MESSAGE GENERATION UNIT
300 TELEVISION RECEIVER
301 CPU
311 DIGITAL TUNER
312 TRANSPORT STREAM BUFFER (TS BUFFER)
313 DEMULTIPLEXER
314 VIDEO DECODER
315 DISPLAY PROCESSING UNIT
316 MESSAGE GENERATION UNIT
317 SUPERIMPOSITION UNIT
318 AUDIO DECODER
319 CHANNEL PROCESSING UNIT
320 HDMI TERMINAL
321 HDMI RECEIVING UNIT

1. A transmission apparatus comprising:
an image data obtainment unit that obtains image data; and
a transmission unit that transmits the obtained image data to an external apparatus,
wherein when the image data that is obtained is items of image data on a left eye view and a right eye view that make up a stereoscopic image, the transmission unit transmits the image data on each of the left eye view and the right eye view in a stereoscopic image transfer format, and
wherein when the image data that is obtained is two-dimensional image data, the transmission unit transmits the two-dimensional image data in the stereoscopic image transfer format.

2. The transmission apparatus according to claim 1,
wherein when transmitting the two-dimensional image data, the transmission unit reformats the two-dimensional image data, and thus generates first image data and second image data that have to be inserted into insertion portions of the items of image data on the left eye view and the right eye view, respectively.

3. The transmission apparatus according to claim 2, further comprising:
an information obtainment unit that obtains information for a stereoscopic display method in the external apparatus,
wherein according to the obtained information for the stereoscopic display method, the transmission unit performs reformatting of the two-dimensional image data and thus obtains the first image data and the second image data.

4. The transmission apparatus according to claim 3,
wherein when the stereoscopic display method is a polarization method, the transmission unit divides the two-dimensional image data into image data in even lines and image data in odd lines, configures the first image data from the image data in even lines, and configures the second image data from the image data in odd lines.

5. The transmission apparatus according to claim 3,
wherein when the stereoscopic display method is a shutter method, the transmission unit configures each frame of the first image data from each frame of the two-dimensional image data and configures each frame of the second image data from an interpolation frame between each frame of the two-dimensional image data.

6. The transmission apparatus according to claim 1,
wherein when transmitting the two-dimensional image data, the transmission unit sets the two-dimensional image data to be first image data and second image data that have to be inserted into insertion portions of the items of image data on the left eye view and the right eye view, respectively, and transmits identification information indicating that the first image data and the second image data are the items of two-dimensional image data that are the same.

7. The transmission apparatus according to claim 1,
wherein the transmission unit transmits message information suggesting that a user should perform a specific viewing action, which is in accordance with the image data that is transmitted in the stereoscopic image transfer format.

8. The transmission apparatus according to claim 1, further comprising:
a superimposition unit that superimposes display data on a message suggesting that a user should perform a specific viewing action, onto the obtained image data.

9. A transmission method comprising:
an image data obtainment step of obtaining image data; and
a transmission step of transmitting the obtained image data to an external apparatus,
wherein in the transmission step, when the image data that is obtained is items of image data on a left eye view and a right eye view that make up a stereoscopic image, the image data on each of the left eye view and the right eye view is transmitted in a stereoscopic image transfer format, and
wherein in the transmission step, when the image data that is obtained is two-dimensional image data, the two-dimensional image data is transmitted in the stereoscopic image transfer format.

10. A receiver comprising:
a receiving unit that receives first image data and second image data that are transmitted, in a stereoscopic transfer format, from an external apparatus, and that receives identification information indicating whether the first image data and the second image data are items of image data on a left eye view and a right eye view that make up a stereoscopic image or are items of two-dimensional image data that are the same; and
a processing unit that obtains display image data by performing processing on the first image data and the second image data that are received, based on the received identification information.

11. The receiver according to claim 10,
wherein when the identification information indicates that the first image data and the second image data are the items of image data on the left eye view and the right eye view that make up the stereoscopic image, the processing unit obtains display image data for displaying the stereoscopic image by processing the first image data and the second image data, and
wherein when the identification information indicates that the first image data and the second image data are the items of two-dimensional image data that are the same, the processing unit obtains display image data for displaying a two-dimensional image by using one of the first image data and the second image data.

12. A receiving method comprising:
a receiving step of receiving first image data and second image data that are transmitted, in a stereoscopic transfer format, from an external apparatus and of receiving identification information indicating whether the first image data and the second image data are items of image data on a left eye view and a right eye view that make up a stereoscopic image or are items of two-dimensional image data that are the same; and
a processing step of obtaining display image data by performing processing on the first image data and the second image data that are received, based on the received identification information.

13. A receiver comprising:
a receiving unit that receives image data that is transmitted, in a stereoscopic transfer format, from an external apparatus, and that receives message information indicating a message suggesting that a user should perform a specific action, which is in accordance with whether the image data is image data for displaying stereoscopic image or is image data for displaying a two-dimensional image;
a processing unit that obtains display image data for displaying the stereoscopic image or the two-dimensional image by processing the received image data;
a message generation unit that obtains message display data, based on the received message information; and
a superimposition unit that superimposes the obtained message display data onto the obtained display image data.

14. The receiver according to claim 13, further comprising:
a control unit that controls operation of shutter glasses, based on the received message information,
wherein a stereoscopic display method is a shutter method.

15. A receiving method comprising:
a receiving step of receiving image data that is transmitted, in a stereoscopic transfer format, from an external apparatus and of receiving message information indicating a message suggesting that a user should perform a specific action, which is in accordance with whether the image data is image data for displaying stereoscopic image or is image data for displaying a two-dimensional image;
a processing step of obtaining display image data for displaying the stereoscopic image or the two-dimensional image by processing the received image data;
a message generation step of obtaining message display data, based on the received message information; and
a superimposition step of superimposing the obtained message display data onto the obtained display image data.

16. A transmission apparatus comprising:
an image data obtainment unit that obtains image data; and
a transmission unit that transmits the image data to an external apparatus,
wherein when the image data that is obtained is items of image data on multiple views that make up a stereoscopic image, the transmission unit transmits the image data on each of the multiple views in a stereoscopic image transfer format, and
wherein when the image data that is obtained is two-dimensional image data, the transmission unit transmits the two-dimensional image data in the stereoscopic image transfer format.
